(19) United States
(12) Patent Application Publication
(10) Pub. No.: US 2025/0053297 A1
(43) Pub. Date: Feb. 13, 2025

(54) INFORMATION PROCESSING APPARATUS AND CONTROL METHOD

(71) Applicant: Lenovo (Singapore) Pte. Ltd., Singapore (SG)

(72) Inventors: Yoshinori Ito, Kanagawa (JP); Yuichi Sone, Kanagawa (JP)

(73) Assignee: Lenovo (Singapore) Pte. Ltd., Singapore (SG)

(21) Appl. No.: 18/782,394

(22) Filed: Jul. 24, 2024

(30) Foreign Application Priority Data
Aug. 7, 2023 (JP) 2023-128774

(51) Int. Cl. G06F 3/04886; G06F 3/04817

(52) U.S. Cl. CPC G06F 3/04886; G06F 3/04817; G06F 2203/04803

(57) ABSTRACT

An information processing apparatus controls switching between a first display mode to control display using the entire screen area of a display as one display area, and a second display mode to control display by splitting the screen area of the display into multiple display areas, and when switching from the first display mode to the second display mode, one window among windows of applications running in the first display mode is displayed in a first display area among the display areas, and thumbnail images corresponding to windows except the one window among the windows in the first display mode are displayed in a second display area among the display areas, and due to the fact that a predetermined operation by a user is detected, the thumbnail images are displayed in a display area specified by the predetermined operation among the display areas inside the screen area.

### CROSS-REFERENCE TO RELATED APPLICATIONS

This application claims priority to Japanese Patent Application No. 2023-128774 filed on Aug. 7, 2023, the contents of which are hereby incorporated herein by reference in their entirety.

### BACKGROUND

### Technical Field

The present invention relates to an information processing apparatus and a control method.

### Description of Related Art

In recent years, there is an information processing device having multiple screens (for example, two screens). For example, there is disclosed an information processing device with a two-screen structure having two displays (display units) respectively equipped in a first chassis and a second chassis foldable through a coupling part (hinge mechanism) (for example, see Japanese Unexamined Patent Application Publication No. 2015-233198). Further, there is an information processing device with a flexible display (display unit) such as an organic EL display provided over a first chassis and a second chassis to be bendable according to the folding of the information processing device (for example, see Japanese Unexamined Patent Application Publication No. 2018-013850). Even when one display (display unit) is provided over the first chassis and the second chassis in this way, it is possible not only to use the one display as a one-screen mode but also to use the one display as a two-screen mode in a pseudo manner by splitting the one display into a display area on the side of the first chassis and a display area on the side of the second chassis. Even in the information processing device with the two-screen structure by the two displays described above, it is also possible to use the two displays not only in the two-screen mode but also in the one-screen mode using the two displays as one screen.

For example, in Japanese Unexamined Patent Application Publication No. 2022-070081, there is disclosed an information processing device in which, in response to switching from the one-screen mode to the two-screen mode related to the display of windows of running applications, an active window in the one-screen mode is displayed on one of the two screens, and thumbnail images corresponding to windows other than the active window are displayed on the other screen. Since this information processing device can make it easier not only to continue using an application used in the one-screen mode when switching from the one-screen mode to the two-screen mode, but also to check thumbnail images as a list of other running applications, it is convenient. A user can perform an operation to select a thumbnail image so as to display and use a window of an application corresponding to the selected thumbnail image.

However, for example, in the technology disclosed in Japanese Unexamined Patent Application Publication No. 2022-070081 described above, the user can perform the operation to select a thumbnail image so as to display a window of an application that the user wants to use, but it is not easy to switch to another application when the user wants to use the other application. Especially, in the case of the two-screen mode, and further when the user uses the information processing device by splitting the display into three or more multiple display areas, it is preferable to be able to select a window to be displayed in each display area more freely.

### SUMMARY

The present invention has been made in view of the above circumstances, and it is an object thereof to provide an information processing apparatus and a control method to improve operability when selecting windows to be displayed in multiple display areas, respectively.

The present invention has been made to solve the above problem, and an information processing apparatus according to the first aspect of the present invention includes: a display; a memory which stores a program of an application; and a processor which executes the program of the application stored in the memory to perform control to display a window of the application on the display, wherein the processor performs display mode switching processing to control switching between a first display mode in which display is controlled using the entire screen area of the display as one display area, and a second display mode in which display is controlled by splitting the screen area of the display into multiple display areas, first display control processing in which, when switching from the first display mode to the second display mode by the display mode switching processing, the processor displays, in a first display area among the multiple display areas, one window among windows of applications running in the first display mode, and displays, in a second display area except the first display area among the multiple display areas, thumbnail images corresponding to windows except the one window among the windows in the first display mode, and second display control processing to display the thumbnail images in a display area specified with a predetermined operation by a user among the display areas inside the screen area due to the fact that the predetermined operation by the user is detected.

The above information processing apparatus may be such that, when displaying the thumbnail images in the second display control processing due to the fact that the predetermined operation is detected, the processor also displays a thumbnail image corresponding to the one window among the windows in the first display mode.

The above information processing apparatus may also be such that, after performing control to hide the thumbnail images displayed in the second display area in the second display control processing, the processor displays the thumbnail images in a display area specified by the predetermined operation due to the fact that the predetermined operation is detected.

The above information processing apparatus may further be such that the processor displays, in the screen area of the display, a first icon for accepting a user operation to switch from the first display mode to the second display mode, and when the user operation on the first icon in the first display mode is detected, the processor switches from the first display mode to the second display mode, and the processor accepts a user operation on the first icon as the predetermined operation in the second display mode, and when the operation on the first icon is detected, the processor determines that the predetermined operation is detected and displays the thumbnail images.

Further, the above information processing apparatus may be such that the processor displays, in the screen area of the display, a first icon for accepting a user operation to switch from the first display mode to the second display mode, and a second icon for accepting the predetermined operation, and when an operation on the second icon is detected, the processor determines that the predetermined operation is detected and displays the thumbnail images.

Further, the above information processing apparatus may be such that the second icon accepts an operation to specify a display area in which the thumbnail images are to be displayed from among the multiple display areas split in the second display mode.

Further, the above information processing apparatus may be such that the predetermined operation is a specific pattern of touch operations on a display area in which the user wants to display the thumbnail images.

Further, the above information processing apparatus may be such that the predetermined operation is the specific pattern of touch operations on an area with no window displayed therein inside a display area in which at least one window is displayed among the multiple display areas in the second display mode, and when the predetermined operation is detected, the processor displays the thumbnail images in a display area on which the predetermined operation is performed by the second display control processing.

Further, the above information processing apparatus may be such that, when any one of the thumbnail images displayed in the second display area is selected with a user operation, the processor hides all the thumbnail images displayed in the second display area, and displays a window corresponding to the selected thumbnail image.

Further, the above information processing apparatus may be such that, when a user operation for hiding the thumbnail images displayed in the second display area is performed, the processor hides all the thumbnail images displayed in the second display area.

Further, the above information processing apparatus may be such that, when switching from the first display mode to the second display mode by the display mode switching processing, the processor controls whether or not to display the thumbnail images in the second display area in the first display control processing based on the number of windows in the first display mode.

Further, the above information processing apparatus may be such that, when switching from the first display mode to the second display mode by the display mode switching processing, the processor controls whether or not to display the thumbnail images in the second display area in the first display control processing based on the number of display areas in the second display mode.

Further, a control method for an information processing apparatus according to the second aspect of the present invention is a control method for an information processing apparatus including: a display; a memory which stores a program of an application; and a processor which executes the program of the application stored in the memory to perform control to display a window of the application on the display, the control method including: a display mode switching step of causing the processor to control switching between a first display mode in which display is controlled using the entire screen area of the display as one display area, and a second display mode in which display is controlled by splitting the screen area of the display into multiple display areas; a first display control step in which, when switching from the first display mode to the second display mode by the display mode switching step, the processor displays, in a first display area among the multiple display areas, one window among windows of applications running in the first display mode, and displays, in a second display area except the first display area among the multiple display areas, thumbnail images corresponding to windows except the one window among the windows in the first display mode; and a second display control step of causing the processor to display the thumbnail images in a display area specified with a predetermined operation by a user among the display areas inside the screen area due to the fact that the predetermined operation by the user is detected.

The above-described aspects of the present invention can improve operability when selecting windows to be displayed in multiple display areas, respectively.

### BRIEF DESCRIPTION OF THE DRAWINGS

FIG. 1 is a perspective view illustrating the appearance of an information processing apparatus according to a first embodiment.

FIG. 2 is a side view illustrating an example of the information processing apparatus in a bent state according to the first embodiment.

FIG. 3 is a side view illustrating an example of the information processing apparatus in a flat state according to the first embodiment.

FIG. 4 is a diagram illustrating specific examples of various display modes of the information processing apparatus according to the first embodiment.

FIGS. 5A-5C are diagrams illustrating an example of operation specifications of display mode switching operations according to the first embodiment.

FIG. 6 is a diagram illustrating a display example of a two-screen mode according to the first embodiment.

FIGS. 7A-7B are diagrams illustrating a first example of display control upon switching from a one-screen mode to the two-screen mode according to the first embodiment.

FIGS. 8A-8B are diagrams illustrating a second example of display control upon switching from the one-screen mode to the two-screen mode according to the first embodiment.

FIG. 9 is a diagram illustrating a first example of a thumbnail display operation according to the first embodiment.

FIGS. 10A-10B are diagrams illustrating a first example of display control by the thumbnail display operation according to the first embodiment.

FIG. 11 is a diagram illustrating a second example of a thumbnail display operation according to the first embodiment.

FIGS. 12A-12B are diagrams illustrating a second example of display control by the thumbnail display operation according to the first embodiment.

FIGS. 13A-13B are diagrams illustrating a third example of display control by a thumbnail display operation according to the first embodiment.

FIG. 14 is a block diagram illustrating a hardware configuration example of the information processing apparatus according to the first embodiment.

FIG. 15 is a block diagram illustrating a functional configuration example related to display control processing according to the first embodiment.

FIG. 16 is a flowchart illustrating an example of thumbnail window display control processing according to the first embodiment.

FIG. 17 is a flowchart illustrating an example of display control processing when a thumbnail image is selected according to the first embodiment.

FIG. 18 is a flowchart illustrating an example of thumbnail window display control processing by a thumbnail display operation according to the first embodiment.

FIG. 19 is a diagram illustrating a first example of a thumbnail display operation according to a second embodiment.

FIGS. 20A-20B are diagrams illustrating a first example of display control by the thumbnail display operation according to the second embodiment.

FIG. 21 is a diagram illustrating a second example of a thumbnail display operation according to the second embodiment.

FIGS. 22A-22B are diagrams illustrating a second example of display control by the thumbnail display operation according to the second embodiment.

FIGS. 23A-23B are diagrams illustrating an example of operation specifications of display mode switching operations according to a third embodiment.

FIGS. 24A-24B are diagrams illustrating a first example of display control upon switching from the one-screen mode to a three-screen mode according to the third embodiment.

FIGS. 25A-25B are diagrams illustrating a second example of display control upon switching from the one-screen mode to the three-screen mode according to the third embodiment.

FIGS. 26A-26B are diagrams illustrating a third example of display control upon switching from the one-screen mode to the three-screen mode according to the third embodiment.

FIG. 27 is a flowchart illustrating an example of thumbnail window display control processing according to the third embodiment.

FIGS. 28A-28B are diagrams illustrating a fourth example of display control upon switching from the one-screen mode to the three-screen mode according to the third embodiment.

FIG. 29 is a diagram illustrating an example of a thumbnail display operation according to the third embodiment.

FIGS. 30A-30B are diagrams illustrating a first example of display control by the thumbnail display operation according to the third embodiment.

FIGS. 31A-31B are diagrams illustrating a second example of display control by a thumbnail display operation according to the third embodiment.

### DETAILED DESCRIPTION

Embodiments of the present invention will be described below with reference to the accompanying drawings.

### First Embodiment

First, an overview of a first embodiment of the present invention will be described.

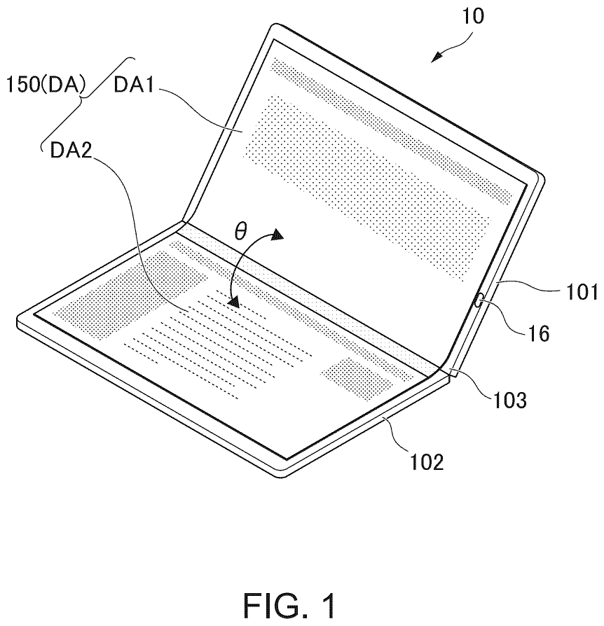

FIG. 1 is a perspective view illustrating the appearance of an information processing apparatus 10 according to the present embodiment. The information processing apparatus 10 according to the present embodiment is a clamshell (laptop) PC (Personal Computer). The information processing apparatus 10 includes a first chassis 101, a second chassis 102, and a hinge mechanism 103. The first chassis 101 and the second chassis 102 are chassis having a substantially rectangular plate shape (for example, a flat plate shape). One of the sides of the first chassis 101 and one of the sides of the second chassis 102 are joined (coupled) through the hinge mechanism 103 in such a manner that the first chassis 101 and the second chassis 102 are rotatable relative to each other around the rotation axis of the hinge mechanism 103. A state where an open angle θ between the first chassis 101 and the second chassis 102 around the rotation axis is substantially 0° is a state where the first chassis 101 and the second chassis 102 overlap each other and are closed. The state where the first chassis 101 and the second chassis 102 are closed is called a “closed state.” Surfaces of the first chassis 101 and the second chassis 102 on the sides to face each other in the closed state are called “inner surfaces,” respectively, and surfaces on the other sides of the inner surfaces are called “outer surfaces.” The open angle θ can also be called an angle between the inner surface of the first chassis 101 and the inner surface of the second chassis 102. A state opposite to the closed state, where the first chassis 101 and the second chassis 102 are open, is called an “open state.” The open state is a state where the first chassis 101 and the second chassis 102 are rotated relative to each other until the open angle θ exceeds a preset threshold value (for example, 10°).

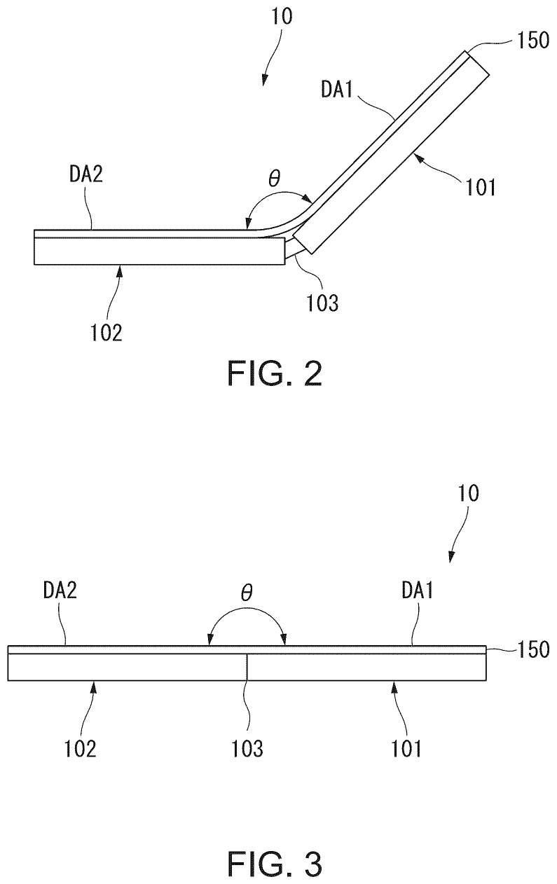

Further, the information processing apparatus 10 includes a camera 16 and a display 150. The camera 16 is provided on the inner surface of the first chassis 101. The display 150 is provided from the inner surface of the first chassis 101 to the inner surface of the second chassis 102. The camera 16 is provided, for example, in an outer part of a screen area of the display 150 on the inner surface of the first chassis 101 to be able to image a user and the like present on the side facing the display 150. The display 150 is a flexible display bendable to fit the open angle θ by relative rotation of the first chassis 101 and the second chassis 102 (see FIG. 2 and FIG. 3). As the flexible display, an organic EL display or the like is used. The information processing apparatus 10 can control not only the display as a one-screen structure in which the entire screen area of the display 150 is used as one display area DA, but also the display as a two-screen structure in which the screen area of the display 150 is split into two display areas of a first display area DA1 and a second display area DA2. Here, the first display area DA1 and the second display area DA2 are display areas that do not overlap each other. It is assumed here that a display area corresponding to the inner surface side of the first chassis 101 within the screen area of the display 150 is the first display area DA1, and a display area corresponding to the inner surface side of the second chassis 102 is the second display area DA2. In the following, a display mode to control the display in the one-screen structure is called a “one-screen mode,” and a display mode to control the display in the two-screen structure is called a “two-screen mode.”

Note that a touch sensor is provided on the screen area of the display 150. The information processing apparatus 10 can detect touch operations on the screen area of the display 150. A user can visually recognize the screen area of the display 150 provided on the respective inner surfaces of the first chassis 101 and the second chassis 102 and perform touch operations on the display 150 by putting the information processing apparatus 10 into the open state, thus enabling the use of the information processing apparatus 10.

Next, usage forms and screen modes of the information processing apparatus 10 will be described in detail. First, the usage forms of the information processing apparatus 10 are classified by the open angle θ between the first chassis 101 and the second chassis 102 into a bent state in which the first chassis 101 and the second chassis 102 are bent (Bent form), and a flat state in which the first chassis 101 and the second chassis 102 are not bent (Flat form). In the following, the state where the first chassis 101 and the second chassis 102 are bent (Bent form) is simply called the “bent state (Bent form),” and the flat state where the first chassis 101 and the second chassis 102 are not bent (Flat form) is simply called the “flat state (Flat form).” In the bent state (Bent form), the display 150 provided over the first chassis 101 and the second chassis 102 is also in the bent state. In the flat state (Flat form), the display 150 is also in the flat state.

FIG. 2 is a side view illustrating an example of the information processing apparatus 10 in the bent state (Bent form). The display 150 is arranged over (across the border between) the first chassis 101 and the second chassis 102. The screen area of the display 150 (the display area DA illustrated in FIG. 1) can be bent using a part corresponding to the hinge mechanism 103 as a crease, and on the border of this crease, a display area on the side of the first chassis 101 is illustrated as the first display area DA1, and a display area on the side of the second chassis 102 is illustrated as the second display area DA2. The display 150 is bent according to the rotation of (the open angle θ between) the first chassis 101 and the second chassis 102. The information processing apparatus 10 determines whether or not the state is the bent state (Bent form) according to the open angle θ. As an example, in the case of 10°<θ<170°, the information processing apparatus 10 determines that the state is the bent state (Bent form). This state corresponds to a usage form as a so-called clamshell mode or a book mode.

FIG. 3 is a side view illustrating an example of the information processing apparatus 10 in the flat state (Flat form). The information processing apparatus 10 typically determines that the state is the flat state (Flat form) when the open angle θ is 180°, but as an example, the information processing apparatus 10 may also determine that the state is the flat state (Flat form) when the open angle θ is in a range of 170° θ<180°. For example, when the open angle θ between the first chassis 101 and the second chassis 102 is 180°, the display 150 is also in the flat state. This state corresponds to a usage form as a so-called tablet mode.

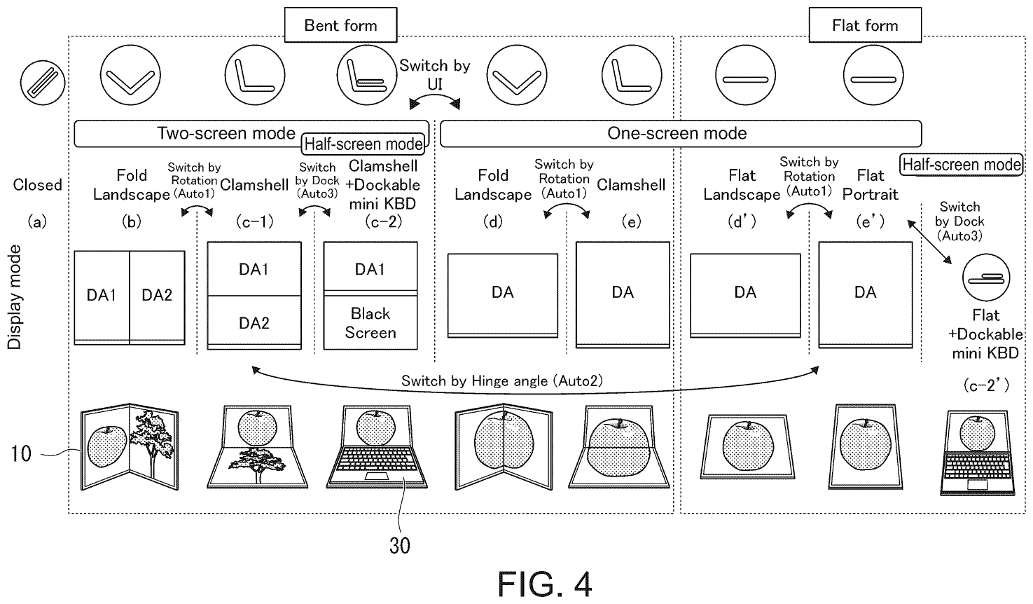

Referring next to FIG. 4, display modes by various usage forms of the information processing apparatus 10 will be described in detail.

FIG. 4 is a diagram illustrating specific examples of various display modes of the information processing apparatus 10 according to the present embodiment. The display mode of the information processing apparatus 10 varies depending on the usage form classified by the open angle θ between the first chassis 101 and the second chassis 102, the posture (orientation) of the information processing apparatus 10, whether the mode is the one-screen mode or the two-screen mode, and the like. Note that one screen is also called a single screen, and two screens are also called spilt screens or dual screens.

Display mode (a) is a display mode when the first chassis 101 and the second chassis 102 are in the closed state (Closed) as the usage form. For example, in this closed state, the information processing apparatus 10 is in a standby state such as a sleep or hibernation state, and the display 150 is in a display-off state. This standby state such as the sleep or hibernation state corresponds, for example, to S3 or S4 as system power status defined in the ACPI (Advanced Configuration and Power Interface) specification.

Display mode (b) is a display mode in the bent state (Bent form) as the usage form and in the two-screen mode in which the display is controlled by splitting the screen area of the display 150 into the two display areas of the first display area DA1 and the second display area DA2. Further, the orientation of the information processing apparatus 10 is an orientation in which the first display area DA1 and the second display area DA2 are lined up side by side in portrait orientation. The portrait orientation of the display areas means an orientation in which long sides of the four sides of each of rectangular display areas are vertical and short sides are horizontal. When the display areas are in portrait orientation, the display orientation is also portrait orientation, and the display is provided in such an orientation that the direction along the long sides corresponds to the up-down direction and the direction along the short sides corresponds to the left-right direction. This usage form is a usage form in which left and right screens correspond to left and right pages when a book is opened, which corresponds to the so-called book mode. Since this usage form is the bent state (Bent form) and the display area obtained by combining the two display areas of the first display area DA1 and the second display area DA2 lined up side by side is horizontally long, it is also called “Fold Landscape.”

In this display mode (b), the information processing apparatus 10 is in a two-screen display mode in which the first display area DA1 on the left side is a primary screen and the second display area DA2 on the right side is a secondary screen, for example, in the normal operating state. Note that the correspondence relationship of the first display area DA1 and the second display area DA2 with the primary screen and the secondary screen in the display mode (b) may be reversed.

Like the display mode (b), display mode (c-1) is a display mode in the bent state (Bent form) and in the two-screen mode in which the display is controlled by splitting the screen area of the display 150 into the two display areas of the first display area DA1 and the second display area DA2, but the display mode (c-1) is a usage form different from the display mode (b) in terms of the orientation of the information processing apparatus 10. The orientation of the information processing apparatus 10 is an orientation in which the first display area DA1 and the second display area DA2 are vertically lined up and down in landscape orientation. The landscape orientation of the display areas means an orientation in which long sides of the four sides of each of the rectangular display areas are horizontal and short sides are vertical. When the display areas are in landscape orientation, the display orientation is also landscape, and the display is provided in such an orientation that the direction along the short sides corresponds to the up-down direction and the direction along the long sides corresponds to the left-right direction. This usage form is one of typical usage forms of a clamshell PC.

In this display mode (c-1), the information processing apparatus 10 is in the two-screen display mode in which the first display area DA1 is the primary screen and the second display area DA2 is the secondary screen, for example, in the normal operating state. Note that the correspondence relationship of the first display area DA1 and the second display area DA2 with the primary screen and the secondary screen in the display mode (c-1) may be reversed.

For example, the information processing apparatus 10 detects a change in the posture (orientation) of the information processing apparatus 10 to automatically switch from the display mode (b) to the display mode (c-1) or from the display mode (c-1) to the display mode (b) (Switch by Rotation). For example, since the display mode (c-1) is in such a state that the display 150 is rotated 90 degrees to the right from the state of the display mode (b) in FIG. 4, the information processing apparatus 10 switches to the display mode (c-1) when detecting the rotation of a predetermined angle (for example, 45 degrees) or more to the right from the state of the display mode (b). Further, since the display mode (b) is in such a state that the display 150 is rotated 90 degrees to the left from the state of the display mode (c-1) in FIG. 4, the information processing apparatus 10 switches to the display mode (b) when detecting the rotation of a predetermined angle (for example, 45 degrees) or more to the left from the state of the display mode (c-1).

Like the display mode (c-1), display mode (c-2) is in the bent state (Bent form) and the orientation of the information processing apparatus 10 is the same, but it is different in that an external keyboard 30 (Dockable mini KBD (Keyboard)) connectable to the information processing apparatus 10 is connected. This usage form is in such a state that a physical keyboard 30 is connected in a general usage form of the clamshell PC. For example, the size of the keyboard 30 is almost equivalent to the size of the second display area DA2, and the keyboard 30 is configured to be mountable on the second display area DA2. As an example, magnets are provided inside the bottom (on the bottom edges) of the keyboard 30, and when the keyboard 30 is mounted on the second display area DA2, the magnets are attracted to metal parts of the inner surface edges of the second chassis 102 and fixed. Thus, the usage form becomes a usage form similar to that of a traditional clamshell PC with a physical keyboard originally provided thereon. Further, the information processing apparatus 10 and the keyboard 30 are connected, for example, through Bluetooth (registered trademark). In this display mode (c-2), since the keyboard makes the second display area DA2 invisible, the information processing apparatus 10 controls the second display area DA2 to black display or display off. In other words, this display mode (c-2) is a display mode in which only half of the screen is enabled to provide a display (hereinafter called a “half-screen mode”), which corresponds to the one-screen mode using only the first display area DA1.

For example, when detecting the connection with the external keyboard in the state of the display mode (c-1), the information processing apparatus 10 automatically switches from the display mode (c-1) to the display mode (c-2) (Switch by Dock).

Like the display mode (b), display mode (d) is in the bent state (Bent form) and the orientation of the information processing apparatus 10 is the same, but it is different in that the display mode (d) is the one-screen mode in which the display is controlled using the entire screen area of the display 150 as one display area DA. Although this usage form is different from the display mode (b) in that the display mode is the one-screen mode, since it is in the bent state (Bent form) and the display area DA is horizontally long, this usage form is also called “Fold Landscape.” The display area DA is in landscape orientation, and the display orientation is also landscape.

Here, switching between the one-screen mode and the two-screen mode in the bent state (Bent form) is performed, for example, with a user operation. For example, the information processing apparatus 10 displays an operating element as a UI (User Interface) capable of switching between the one-screen mode and the two-screen mode somewhere on the screen to switch from the display mode (b) to the display mode (d) based on an operation on the operating element (Switch by UI). A specific example of this display mode switching operation will be described later.

Like the display mode (c-1), display mode (e) is in the bent state (Bent form) and the orientation of the information processing apparatus 10 is the same, but it is different in that the display mode (e) is in the one-screen mode in which the display is controlled using the entire screen area of the display 150 as one display area DA. This usage form is different from the display mode (c-1) in that the display mode (e) is the one-screen mode, but the display mode (e) corresponds to a usage form of the clamshell PC from the bent state (Bent form) and the orientation of the information processing apparatus 10. The display area DA is in portrait orientation and the display orientation is also portrait.

For example, the information processing apparatus 10 detects a change in the posture (orientation) of the information processing apparatus 10 to automatically switch from the display mode (d) to the display mode (e), or from the display mode (e) to the display mode (d) (Switch by Rotation). For example, since the display mode (e) is in such a state that the display 150 is rotated 90 degrees to the right from the state of the display mode (d) in FIG. 4, the information processing apparatus 10 switches to the display mode (e) when detecting the rotation of a predetermined angle (for example, 45 degrees) or more to the right from the state of the display mode (d). Further, since the display mode (d) is in such a state that the display 150 is rotated 90 degrees to the left from the state of the display mode (e) in FIG. 4, the information processing apparatus 10 switches to the display mode (d) when detecting the rotation of a predetermined angle (for example, 45 degrees) or more to the left from the state of the display mode (e).

Like the display mode (d), display mode (d′) is the one-screen mode and the orientation of the information processing apparatus 10 is such an orientation that the display area DA is horizontally long, but it is different in that the information processing apparatus 10 is in the flat state (Flat form). The flat state (Flat form) is a state in which the open angle θ between the first chassis 101 and the second chassis 102 is substantially 180°. This usage form corresponds to the so-called tablet mode described with reference to FIG. 3. Since this usage form is in the flat state (Flat form) and the display area DA is horizontally long, it is also called “Flat Landscape.” This display mode (d′) is different from the display mode (d) only in the open angle θ between the first chassis 101 and the second chassis 102. Like in the display mode (d), the display area DA in the display mode (d′) is in landscape orientation and the display orientation is also landscape.

Like the display mode (e), display mode (e′) is the one-screen mode and the orientation of the information processing apparatus 10 is such an orientation that the display area DA is vertically long, but it is different in that the information processing apparatus 10 is in the flat state (Flat form). Since this usage form is in the flat state (Flat form) and the display area DA is vertically long, it is also called “Flat Portrait.” This display mode (e′) is different from the display mode (e) only in the open angle θ between the first chassis 101 and the second chassis 102. Like in the display mode (e), the display area DA in the display mode (e′) is in portrait orientation and the display orientation is also portrait.

For example, the information processing apparatus 10 detects a change in the posture (orientation) of the information processing apparatus 10 to automatically switch from the display mode (d′) to the display mode (e′), or from the display mode (e′) to the display mode (d′) (Switch by Rotation). For example, since the display mode (e′) is in such a state that the display 150 is rotated 90 degrees to the right from the state of the display mode (d′) in FIG. 4, the information processing apparatus 10 switches to the display mode (e′) when detecting the rotation of a predetermined angle (for example, 45 degrees) or more to the right from the state of the display mode (d′). Further, since the display mode (d′) is in such a state that the display 150 is rotated 90 degrees to the left from the state of the display mode (e′) in FIG. 4, the information processing apparatus 10 switches to the display mode (d′) when detecting the rotation of a predetermined angle (for example, 45 degrees) or more to the left from the state of the display mode (e′).

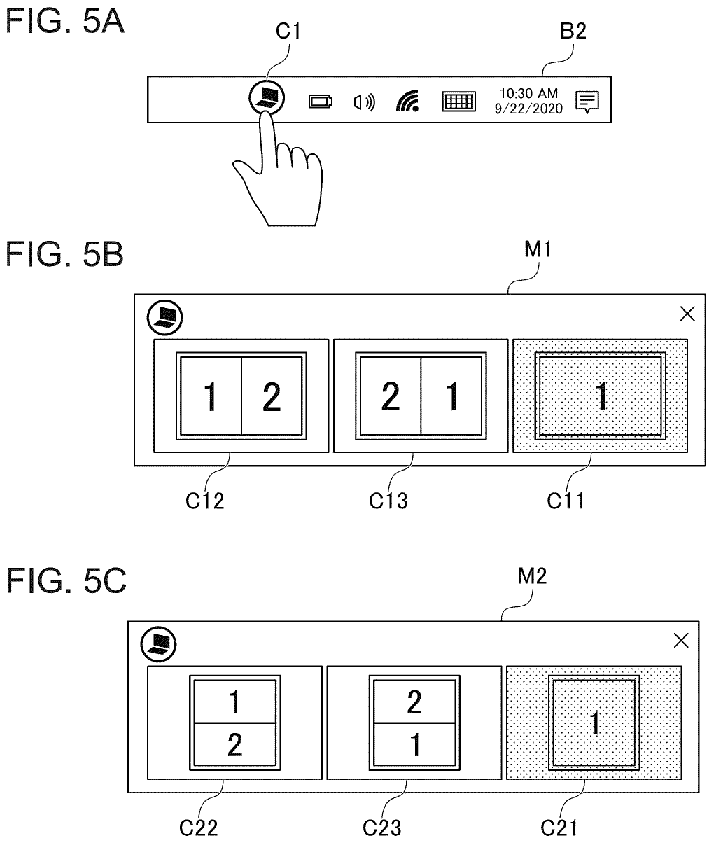

Note that in the display mode (d′) and the display mode (e′), it is also possible to switch to the two-screen mode while keeping the flat state (Flat form) by the user performing an operation on an operating element as the UI capable of switching between the one-screen mode and the two-screen mode described above (for example, on a display mode switching icon to be described later with reference to FIGS. 5A-5C). For example, when switching to the two-screen mode from the state of the display mode (d′), the display state becomes similar to the display mode (b) in the flat state (Flat form). Further, when switching to the two-screen mode from the state of the display mode (e′), the display state becomes similar to the display mode (c-1) in the flat state (Flat form).

Further, when detecting the connection with the keyboard 30 in the state of the display mode (e′), the information processing apparatus 10 automatically switches from the display mode (e′) to display mode (c-2′) (Switch by Dock). The display mode (c-2′) is in the flat state (Flat form) and different from the display mode (c-2) only in the open angle θ between the first chassis 101 and the second chassis 102. In this display mode (c-2′), since the second display area DA2 becomes invisible by the keyboard, the information processing apparatus 10 controls the second display area DA2 to black display or display off. In other words, like the display mode (c-2), this display mode (c-2′) is the half-screen mode in which only one screen area as half of the entire screen area of the display 150 is enabled for display.

Further, the information processing apparatus 10 can also switch automatically from the one-screen mode to the two-screen mode by detecting a change from the flat state (Flat form) to the bent state (Bent form) (Switch by Hinge angle). For example, when detecting a change to the bent state (Bent form) in the state of the display mode (d′) based on the open angle θ between the first chassis 101 and the second chassis 102, the information processing apparatus 10 automatically switches from the display mode (d′) to the display mode (b). Further, when detecting a change to the bent state (Bent form) in the state of the display mode (e′) based on the open angle θ between the first chassis 101 and the second chassis 102, the information processing apparatus 10 automatically switches from the display mode (e′) to the display mode (c-1).

### (Display Mode Switching Operations)

Next, specific examples of operation specifications when switching between display modes with user operations will be described.

FIGS. 5A-5C are diagrams illustrating an example of operation specifications of display mode switching operations according to the present embodiment. For example, as illustrated in FIG. 5A, an icon C1 to display a display mode switching menu is displayed on a task bar B2. The task bar B2 is displayed somewhere in the screen area of the display 150. For example, the task bar B2 is displayed only in one place inside the screen area of the display 150 (for example, at the bottom of the screen area) regardless of the one-screen mode or the two-screen mode. Note that in the case of the two-screen mode, the task bar B2 may also be displayed respectively in the first display area DA1 and the second display area DA2 (for example, at the bottoms of the respective display areas).

When an operation is performed on the icon C1 to display a switching menu, the display mode switching menu is displayed as a pop-up screen. Note that the display mode switching menu may also be displayed as a pop-up screen when the state of the information processing apparatus 10 changes from the bent state (Bent form) to the flat state (Flat form) in which the information processing apparatus 10 is not bent. Further, the display mode switching menu may be displayed as the pop-up screen when the state of the information processing apparatus 10 changes from the flat state (Flat form) to the bent state (Bent form).

On the switching menu, display mode switching icons for allowing the user to give instructions to switch between the one-screen mode and the two-screen mode, and to replace display data to be displayed respectively in the first display area DA1 and the second display area DA2 (to replace the primary screen and the secondary screen) are displayed as display mode options. On the switching menu, the display mode options selectable by the user depending on the usage form (the orientation of the display 150) at the time are displayed.

FIG. 5B illustrates a switching menu M1 displayed when the usage form is “Landscape” (the display mode (b), the display mode (d), the display mode (d′), or the like). Note that “1” and “2” in FIG. 5B are affixed to distinguish between the display areas, which are numbers, for example, according to the area priority preset for respective display areas. For example, in the two-screen mode, “1” is higher in area priority than “2,” that is, “1” indicates the primary screen, and “2” indicates the secondary screen. On the switching menu M1, a display mode switching icon C11, a display mode switching icon C12, and a display mode switching icon C13 are displayed. The display mode switching icon C11 is displayed as an operating element for selecting the display mode (d) or the display mode (d′) in the one-screen mode (that is, as an icon for accepting a user operation for switching to the one-screen mode). The display mode switching icon C12 and the display mode switching icon C13 are displayed as operating elements for selecting the display mode (b) in the two-screen mode, where the display mode switching icon C12 and the display mode switching icon C13 are different in the order of “1” (primary screen) and “2” (secondary screen).

Note that a display mode switching icon corresponding to the current display mode is displayed in a display form distinguishable from the other display mode switching icons. Here, the display mode switching icon C11 is highlighted to distinguish from the other display mode switching icons C12 and C13 to make it clear that the display mode switching icon C11 is the current display mode. In this figure, the display mode switching icon C11 is represented by hatching as highlighting, but the display mode switching icon C11 may also be represented by making the color, contrast, size, frame thickness, or the like different, or by adding a mark or text thereto.

FIG. 5C illustrates a switching menu M2 displayed when the usage form is “Clamshell” or “Portrait” (the display mode (c-1), the display mode (e), the display mode (e′), or the like). On the switching menu M2, a display mode switching icon C21, a display mode switching icon C22, and a display mode switching icon C23 are displayed. The display mode switching icon C21 is displayed as an operating element for selecting the one-screen mode (the display mode (e) or the display mode (e′)). The display mode switching icon C22 and the display mode switching icon C23 are displayed as operating elements for selecting the display mode (c-1) in the two-screen mode, where the display mode switching icon C22 and the display mode switching icon C23 are different in the order of “1” (primary screen) and “2” (secondary screen).

Note that, like the switching menu M1 illustrated in FIG. 5B, a display mode switching icon corresponding to the current display mode is displayed on the switching menu M2 in a display form distinguishable from the other display mode switching icons. Here, the display mode switching icon C21 is highlighted to distinguish from the other display mode switching icons C22 and C23 to make it clear that the display mode switching icon C21 is the current display mode.

The user can select any one of the display mode switching icons displayed on the switching menu M1 or the switching menu M2 arbitrarily. When the user selects any one of the display mode switching icons, the display of the switching menu is ended. Otherwise, when the user selects none of the display mode switching icons even after a predetermined time (for example, three to five seconds) has passed since the switching menu M1 or the switching menu M2 was displayed, the display of the switching menu is ended. Further, when the user presses a close button “x” at the top right of the switching menu, when the user performs an operation outside of the screen of the switching menu being popped up, or when the orientation of the information processing apparatus 10 is changed, the display of the switching menu is ended. Note that in the state where the keyboard 30 is connected, since the half-screen mode (display mode (c-2)) in which only the first display area DA1 is enabled for display is fixed, the switching menu is not displayed.

Note that the UI for switching between the one-screen mode and the two-screen mode is not limited to the example illustrated in FIGS. 5A-5C, and any other UI can be used. For example, an icon that alternately switches between the one-screen mode and the two-screen mode each time the icon is operated, or an icon that switches among the one-screen mode, the two-screen mode, and the reversed two-screen mode in order each time the icon is operated may be displayed on the task bar B2. In the following description, when there is no particular distinction between the two-screen mode and the reversed two-screen mode, both are collectively referred to as the two-screen mode.

Further, in the example illustrated in FIGS. 5A-5C, the display mode switching menu is displayed as the pop-up screen by the operation on the icon C1 displayed on the task bar B2, but the switching menu may also be displayed as a pop-up screen with a drag operation on an application window or the like. Further, the display mode may be switched with the drag operation on the application window or the like. When the switching menu is popped up with the drag operation on the application window, the application window may be dragged into one of split areas of a screen area displayed on the switching menu to make not only a screen mode but also a screen area selectable and to arrange the dragged application in the selected area. Further, the switching menu may be displayed as a pop-up screen with an operation on a specific location of the application window.

(Display Control upon Switching from One-screen Mode to Two-screen Mode)

Next, display control upon switching from the one-screen mode to the two-screen mode will be described. When switching from the one-screen mode to the two-screen mode, the information processing apparatus 10 displays, in the first display area DA1 (for example, on the primary screen), one window among windows of applications (hereinafter simply called “apps”) running in the one-screen mode. For example, the information processing apparatus 10 displays, in the first display area DA1, an active window among the windows of the apps running in the one-screen mode.

Here, when multiple windows are open, the windows are layered and arranged in multiple layers on the display 150, respectively. The active window is a window currently selected as a user operation target, which is, for example, a window being arranged in and displayed on the frontmost layer (the top layer) of the display 150. The active window to be displayed in the first display area DA1 when the information processing apparatus 10 switches from the one-screen mode to the two-screen mode is a window that was being displayed as the active window in the one-screen mode just before switching to the two-screen mode.

Note that, when switching from the one-screen mode to the two-screen mode, the information processing apparatus 10 displays, in the first display area DA1, the active window in the one-screen mode. However, when there is no active window, the information processing apparatus 10 displays, in the first display area DA1, the highest priority window among the windows displayed in the display area DA in the one-screen mode.

Although the highest priority window is typically the active window, when there is no active window, the highest priority window is the last window in order of becoming the active window. For example, when an operation was performed on a location other than windows in the display area DA, the display area DA becomes a state where there is no active window. Therefore, the window that lastly became the active window is displayed in the first display area DA1. In other words, the later the order of becoming the active window, the higher the display priority, resulting in displaying the highest priority window in the first display area DA1. However, to make the description easier to understand, the following description will be made by stating the highest priority window as the “active window.”

Further, when switching from the one-screen mode to the two-screen mode, the information processing apparatus 10 displays, in the second display area DA2 (for example, on the secondary screen), thumbnail images corresponding to inactive windows except the active window among the windows in the one-screen mode. Here, the inactive windows are windows other than the active window in the one-screen mode just before the transition to the two-screen mode. In the following, a window with the thumbnail images of the inactive windows displayed therein is also called a “thumbnail window.”

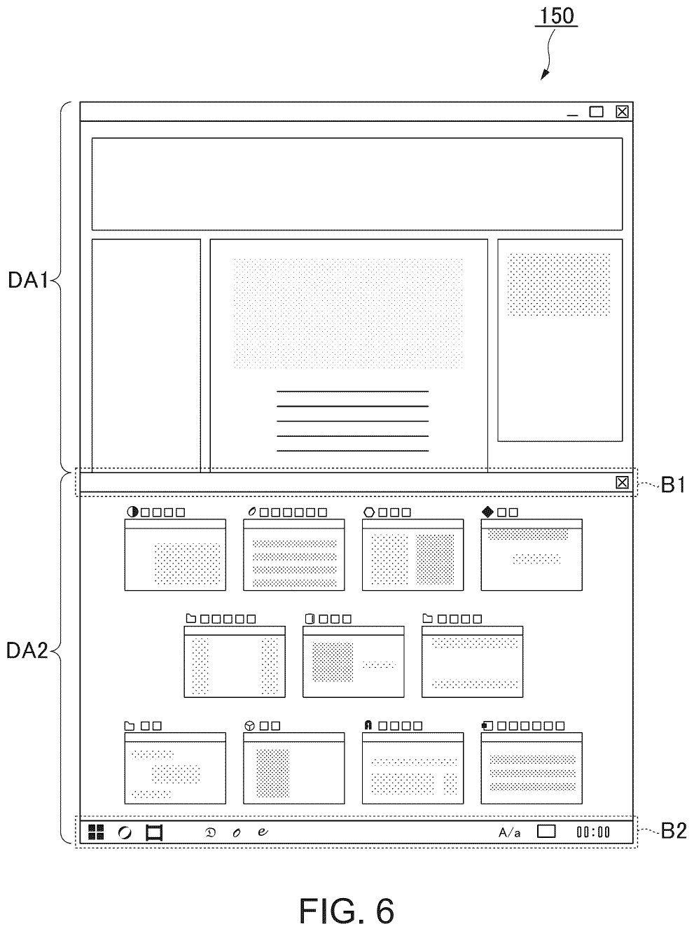

Referring to FIG. 6, a display example of the two-screen mode when the thumbnail window is displayed in the second display area DA2 after switching from the one-screen mode to the two-screen mode will be described.

FIG. 6 is a diagram illustrating a display example of the two-screen mode according to the present embodiment. Here, the display example of the two-screen mode as the display mode (c-1) illustrated in FIG. 4 is illustrated. This usage form is a typical usage form of a clamshell PC in the two-screen mode, where the first display area DA1 and the second display area DA2 are vertically lined up and down in landscape orientation. The landscape orientation of the display areas means an orientation in which long sides of the four sides of each of the rectangular display areas are horizontal and short sides are vertical. The vertical corresponds to the vertical (up and down) direction, and the horizontal corresponds to the horizontal (left and right) direction. The vertical direction is typically the direction perpendicular to the ground. In other words, the first display area DA1 and the second display area DA2 are so arranged that the edge on the lower side in the display orientation of the first display area DA1 becomes the side of the edge on the upper side in the display orientation of the second display area DA2.

When switching from the one-screen mode to the two-screen mode, the information processing apparatus 10 displays, in the first display area DA1, the active window of the app running in the one-screen mode. For example, when the transition to the two-screen mode is made, the information processing apparatus 10 maximizes and displays the active window, displayed in the display area DA in the one-screen mode, in the entire first display area DA1 as the active window. Further, when the transition to the two-screen mode is made, the information processing apparatus 10 arranges windows as inactive windows in the one-screen mode on layers behind the frontmost layer on which the active window is displayed in the first display area DA1 while maintaining the layer relationship (the overlapping order of windows) in the one-screen mode. Therefore, in the first display area DA1, the active window is displayed as the maximized window, and the inactive windows are not displayed though existing on the layers behind the active window (invisible to the user).

Further, when switching from the one-screen mode to the two-screen mode, the information processing apparatus 10 generates a thumbnail image of a window as an inactive window in the one-screen mode, and displays a thumbnail window in the second display area DA2 (on the secondary screen). When there are two or more inactive windows, the information processing apparatus 10 displays, in the second display area DA2, a thumbnail window in which thumbnail images of the two or more inactive windows are lined up.

For example, the thumbnail window is so displayed that the thumbnail images (reduced images) of the two or more windows are lined up in the thumbnail window. A title bar B1 is displayed at the top of the thumbnail window. A close button “x” at the right end of the title bar B1 is displayed as an operating element for closing the thumbnail window. The user can close the thumbnail window to make all the thumbnail images closed (hidden) by performing an operation (for example, a tap operation) on the close button “x” of this title bar B1.

Note that the inactive windows that exist on the layers behind the active window in the first display area DA1 (that is, the main bodies (real windows) of the inactive windows displayed as the thumbnail images in the second display area DA2) may be overlaid one on top of the other so that the inactive windows are hidden behind the active window in the order of priority in the same size as the active window, or may be overlaid one on top of the other in the order of priority in a size smaller than the active window. Further, all the inactive windows (that is, the main bodies (real windows) of the inactive windows displayed in the second display area DA2 as the thumbnail images) may be once minimized (for example, a state where only icons of apps exist on the task bar in Windows (registered trademark)), or when the display of the thumbnail window is not translucent (see-through), the inactive windows may be arranged on the back of the thumbnail window. In short, the main bodies (real windows) of the inactive windows with the thumbnail images displayed in the second display area DA2 have only to be processed to be once invisible to the user. Then, in the second display area DA2, a window of an app of a thumbnail image selected in the thumbnail window after that is displayed in the foreground as an active window.

Further, a task bar B2 displayed on the lower edge of the second display area DA2 corresponds to the task bar B2 illustrated in FIGS. 5A-5C, which is displayed in one place as a task bar common to the first display area DA1 and the second display area DA2. Note that the position at which the task bar B2 is displayed may be the left edge or the right edge of the first display area DA1 or the second display area DA2, or the upper edge of the first display area DA1. Further, as described above, task bars may be displayed in the first display area DA1 and the second display area DA2, respectively. No matter which position the task bar is displayed, the application of the present invention is not limited.

Note that FIG. 6 illustrates the example in which, when the thumbnail images are displayed in the second display area DA2, the thumbnail images are displayed as the thumbnail window with the title bar B1 contained therein, but there may be no display of the title bar B1, or the multiple thumbnail images may be simply displayed side by side.

When any one of the thumbnail images is selected with a user operation (for example, a tap operation), the information processing apparatus 10 closes (hides) the thumbnail window displayed in the second display area DA2, and displays, in the second display area DA2, an inactive window corresponding to the selected thumbnail image as an active window. Specifically, as an example, the information processing apparatus 10 moves the inactive window corresponding to the selected thumbnail image from the first display area DA1 to the second display area DA2, and maximizes and displays the inactive window in the second display area DA2 as an active window.

Here, when the number of windows in the one-screen mode is one, the information processing apparatus 10 displays the active window in the first display area DA1 when switching from the one-screen mode to the two-screen mode, but does not display any thumbnail window in the second display area DA2 because there is no thumbnail image to be displayed. For example, in the second display area DA2, the desktop screen is displayed because there is no window display.

Further, when the number of windows in the one-screen mode is two, the information processing apparatus 10 displays the active window in the first display area DA1 and displays an inactive window other than the active window in the second display area DA2, rather than displaying a thumbnail window, when switching from the one-screen mode to the two-screen mode. This is to avoid complicated operations because, even when a thumbnail image of only one inactive window is displayed in the second display area DA2, there is a need to deliberately perform an operation to select the only one thumbnail image in order to display the window of the thumbnail image. Since there is no need to deliberately perform the operation to select the only one thumbnail image by displaying the only one inactive window in the second display area DA2 as the inactive window, rather than accepting the operation to select the thumbnail image, it is convenient.

In other words, when switching from the one-screen mode to the two-screen mode, the information processing apparatus 10 controls whether or not to display a thumbnail window (thumbnail images) in the second display area DA2 based on the number of windows of apps running in the one-screen mode.

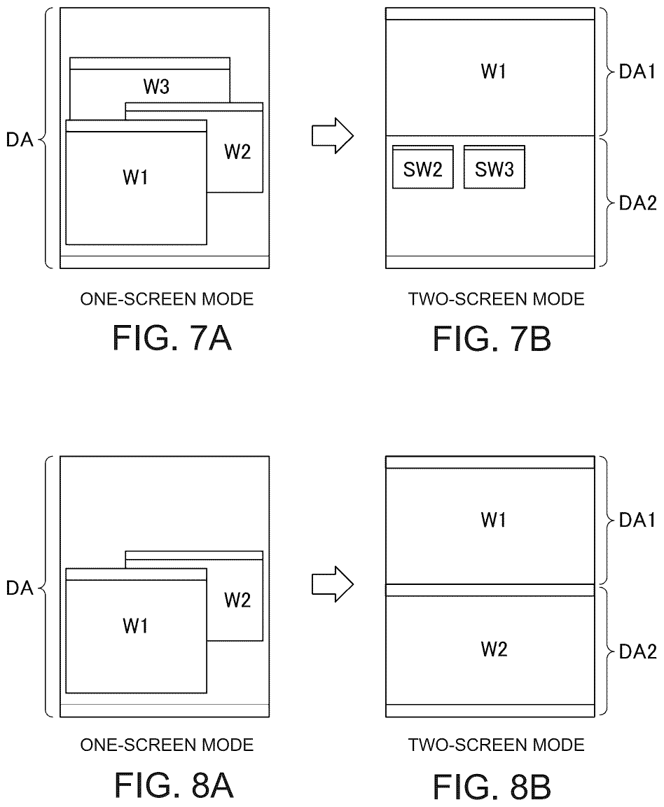

FIGS. 7A-7B are diagrams illustrating a first example of display control upon switching from the one-screen mode to the two-screen mode according to the present embodiment. FIG. 7A illustrates a display example of the one-screen mode, and FIG. 7B illustrates a display example after switching to the two-screen mode. In the illustrated example, the number of windows of apps running in the one-screen mode is three. Here, three windows W1, W2, and W3 are illustrated in the display area DA. The window W1 is an active window arranged on the frontmost layer (top layer). When switching from the one-screen mode to the two-screen mode, the window W1 is maximized and displayed as the active window in the first display area DA1, and a thumbnail window in which thumbnail images SW2 and SW3 of the windows W2 and W3 lined up is displayed in the second display area DA2. Note that, if the number of windows of apps running in the one-screen mode is four or more, the number of thumbnail images displayed in the second display area DA2 when switching to the two-screen mode will also be three or more.

FIGS. 8A-8B are diagrams illustrating a second example of display control upon switching from the one-screen mode to the two-screen mode according to the present embodiment. FIG. 8A illustrates a display example of the one-screen mode, and FIG. 8B illustrates a display example after switching to the two-screen mode. In the illustrated example, the number of windows of apps running in the one-screen mode is two. Here, two windows W1 and W2 are illustrated in the display area DA. The window W1 is an active window arranged on the frontmost layer (top layer). When switching from the one-screen mode to the two-screen mode, the window W1 is maximized and displayed as the active window in the first display area DA1, and the window W2 is maximized and displayed as an inactive window in the second display area DA2. Note that, if the number of windows of apps running in the one-screen mode is one or less, neither a window of an app nor a thumbnail window (a thumbnail image of the window) is displayed in the second display area DA2 when switching to the two-screen mode.

Thus, in the case where switching from the one-screen mode to the two-screen mode is made, when the number of windows in the one-screen mode is more than two (more than the number of display areas in the two-screen mode), the information processing apparatus 10 displays, in the second display area DA2, a thumbnail window in which thumbnail images of windows except the active window among the windows in the one-screen mode are lined up. On the other hand, in the case where switching from the one-screen mode to the two-screen mode is made, when the number of windows in the one-screen mode is equal to or less than two (equal to or less than the number of display areas in the two-screen mode), the information processing apparatus 10 does not display any thumbnail window. Further, when the number of windows in the one-screen mode is two, the information processing apparatus 10 displays, in the second display area DA2, an inactive window in the one-screen mode.

In other words, when switching from the one-screen mode to the two-screen mode, the information processing apparatus 10 controls whether or not to display thumbnail images in the second display area DA2 based on the number of display areas in the two-screen mode and the number of windows in the one-screen mode.

Note that there is a case where a window of an app running in the one-screen mode is minimized. In such a case, the minimized window does not need to be included in the number of windows in the one-screen mode.

For example, in the case where the window W3 is minimized in the one-screen mode as illustrated in FIG. 7A, when switching to the two-screen mode as the number of windows in the one-screen mode is two, that is, the windows W1 and W2, the window W1 may be maximized and displayed as the active window in the first display area DA1 and the window W2 may be maximized and displayed as an inactive window in the second display area DA2 as illustrated in FIG. 8B.

Here, since the user can select any thumbnail image to display the window, it is convenient when there are many windows of running apps, but there is a case where the user wants to switch to another window in order to display the other window, or the user wants to specify any one of the first display area DA1 and the second display area DA2 when displaying the window.

Therefore, the information processing apparatus 10 according to the present embodiment can display (redisplay) thumbnail images of windows of running apps by the user performing a predetermined operation. In the following, this predetermined operation to display (redisplay) thumbnail images is called a “thumbnail display operation.”

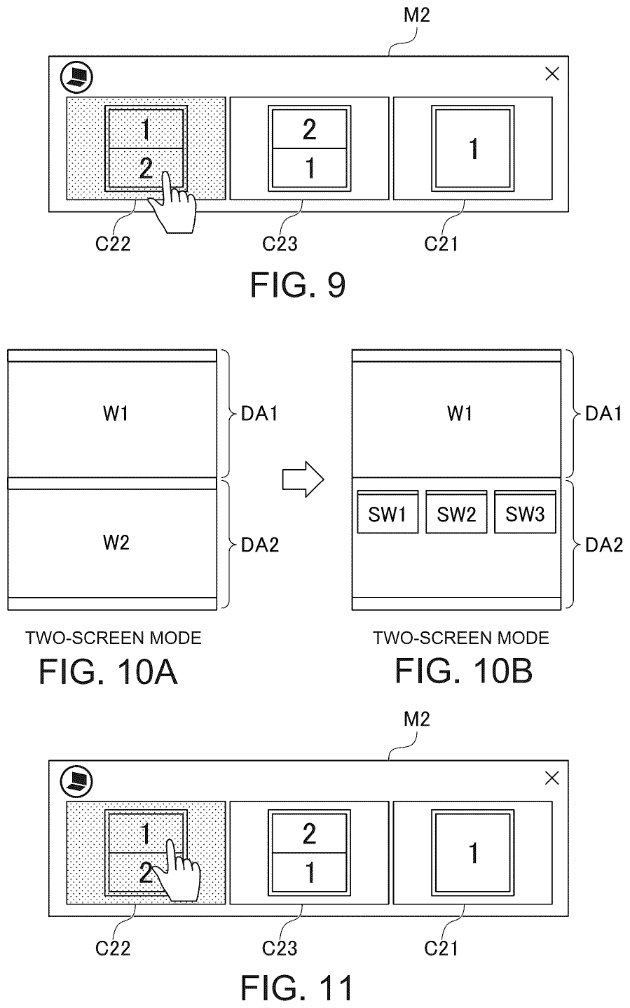

FIG. 9 is a diagram illustrating a first example of a thumbnail display operation according to the present embodiment. A switching menu M2 in FIG. 9 corresponds to the switching menu M2 illustrated in FIG. 5C. This switching menu M2 illustrated in FIG. 9 is displayed when the usage form is “Clamshell” or “Portrait” (the display mode (c-1), the display mode (e), the display mode (e′), or the like), which indicates that the current display mode is the two-screen mode corresponding to the display mode switching icon C22.

Since the display mode switching icon C22 is the current display mode, the display mode switching icon C22 is highlighted to distinguish from the other display mode switching icons C21 and C23. As described with reference to FIGS. 5A-5C, the display mode switching icons C21 and C23 function as operating elements for accepting user operations to switch to respective display modes. On the other hand, since the display mode switching icon C22 as the current display mode does not need to function as an operating element for switching between display modes, the display mode switching icon C22 functions as an operating element for displaying thumbnail images (a thumbnail window). In other words, the display mode switching icon C22 as the current display mode is displayed as an icon for accepting a thumbnail display operation. For example, an example of display control for displaying a thumbnail window in the second display area DA2 by the user performing an operation for selecting a display area indicated by “2” (the second display area DA2) on this display mode switching icon C22 is illustrated in FIGS. 10A-10B.

FIGS. 10A-10B are diagrams illustrating a first example of display control by the thumbnail display operation according to the present embodiment. FIG. 10A illustrates an example in which the window W1 is maximized and displayed in the first display area DA1 and the window W2 is maximized and displayed in the second display area DA2, respectively, in the two-screen mode. For example, in FIG. 7B, when an operation to select the thumbnail image SW2 between the thumbnail images SW2 and SW3 being displayed in the second display area DA2, the display state is controlled to the display state illustrated in FIG. 10A. Note that the display state in FIG. 10A is also the display state illustrated in FIG. 8B.

In the display state illustrated in FIG. 10A, when the user performs the operation to select the display area indicated by “2” (the second display area DA2) on the display mode switching icon C22 as illustrated in FIG. 9, a thumbnail window is displayed in the second display area DA2 as illustrated in FIG. 10B. At this time, all thumbnail images of windows of running apps are displayed in the thumbnail window of the second display area DA2. For example, in the case where the number of windows of running apps is three (that is, the windows W1, W2, and W3) as illustrated in FIGS. 7A-7B, when the thumbnail display operation is performed, three thumbnail images (thumbnail images SW1, SW2, and SW3) are displayed as illustrated in FIG. 10B.

The thumbnail display operation when the usage form is “Clamshell” or “Portrait” (the display mode (c-1), the display mode (e), the display mode (e′), or the like) is described with reference to FIG. 9 and FIGS. 10A-10B, but even when the usage form is “Landscape” (the display mode (b), the display mode (d), the display mode (d′), or the like), a thumbnail display operation can also be performed in the same way using the switching menu M1 illustrated in FIG. 5B.

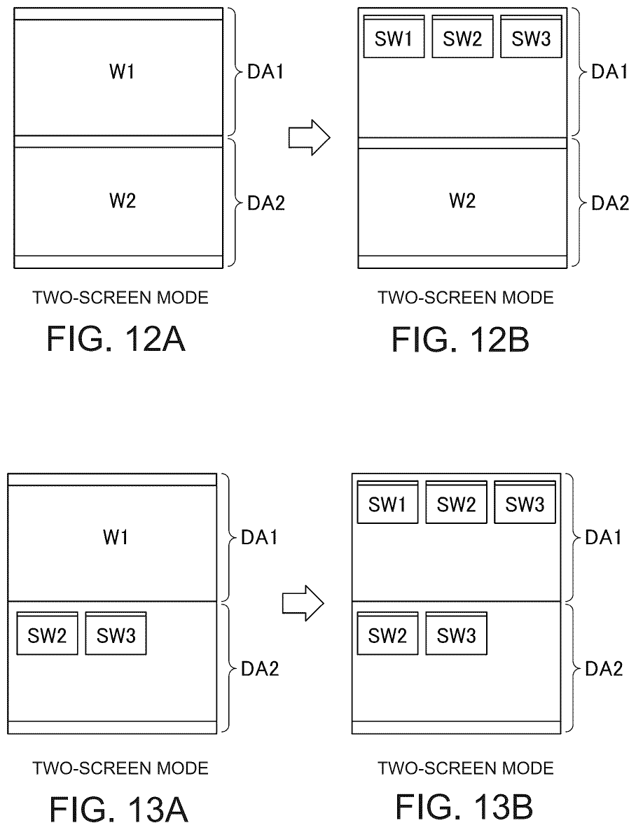

Further, the example in which the second display area DA2 is specified by the thumbnail display operation to display a thumbnail window in the second display area DA2 is described with reference to FIG. 9 and FIGS. 10A-10B. Referring next to FIG. 11 and FIGS. 12A-12B, an example in which the first display area DA1 is specified to display a thumbnail window in the first display area DA1 will be described.

FIG. 11 is a diagram illustrating a second example of a thumbnail display operation according to the present embodiment. The switching menu M2 illustrated in FIG. 11 is the same as that in the example illustrated in FIG. 9, which indicates that the current display mode is the two-screen mode corresponding to the display mode switching icon C22. An example of display control to display a thumbnail window in the first display area DA1 by the user performing an operation to select a display area indicated by “1” (the first display area DA1) on this display mode switching icon C22 is illustrated in FIGS. 12A-12B.

FIGS. 12A-12B are diagrams illustrating a second example of display control by the thumbnail display operation according to the present embodiment. Like FIG. 10A, FIG. 12A illustrates an example in which the window W1 is maximized and displayed in the first display area DA1 and the window W2 is maximized and displayed in the second display area DA2 in the two-screen mode. In this display state illustrated in FIG. 12A, when the user performs the operation to select the display area indicated by “1” (the first display area DA1) on the display mode switching icon C22 as illustrated in FIG. 11, a thumbnail window is displayed in the first display area DA1 as illustrated in FIG. 12B. At this time, all thumbnail images of windows of running apps are displayed in the thumbnail window of the first display area DA1. For example, in the case where the number of windows of running apps is three (the windows W1, W2, and W3), when the thumbnail display operation is performed, three thumbnail images (thumbnail images SW1, SW2, and SW3) are displayed as illustrated in FIG. 12B.

Note that any thumbnail display operation may also be enabled even when a thumbnail window is displayed. FIGS. 13A-13B are diagrams illustrating a third example of display control by a thumbnail display operation according to the present embodiment. FIG. 13A illustrates an example in which the window W1 is displayed in the first display area DA1 and the thumbnail window is displayed in the second display area DA2, respectively, in the two-screen mode as illustrated in FIG. 7B. In this display state illustrated in FIG. 13A, when the user performs an operation to select the display area indicated by “1” (the first display area DA1) on the display mode switching icon C22 as illustrated in FIG. 11, a thumbnail window is displayed in the first display area DA1 as illustrated in FIG. 13B. At this time, unlike the thumbnail window of the second display area DA2, all the thumbnail images of the windows of the running apps are displayed in the thumbnail window of the first display area DA1. For example, in the case where the number of windows of running apps is three (the windows W1, W2, and W3), when the thumbnail display operation is performed, three thumbnail images (thumbnail images SW1, SW2, and SW3) are displayed as illustrated in FIG. 13B.

Thus, when a display area is specified by a thumbnail display operation to display a thumbnail window, windows to be displayed in the specified display area can be selected from among the windows of the running apps regardless of the active window or the inactive windows.

### (Configurations of Information Processing Apparatus 10)

Specific configurations of the information processing apparatus 10 will be described below.

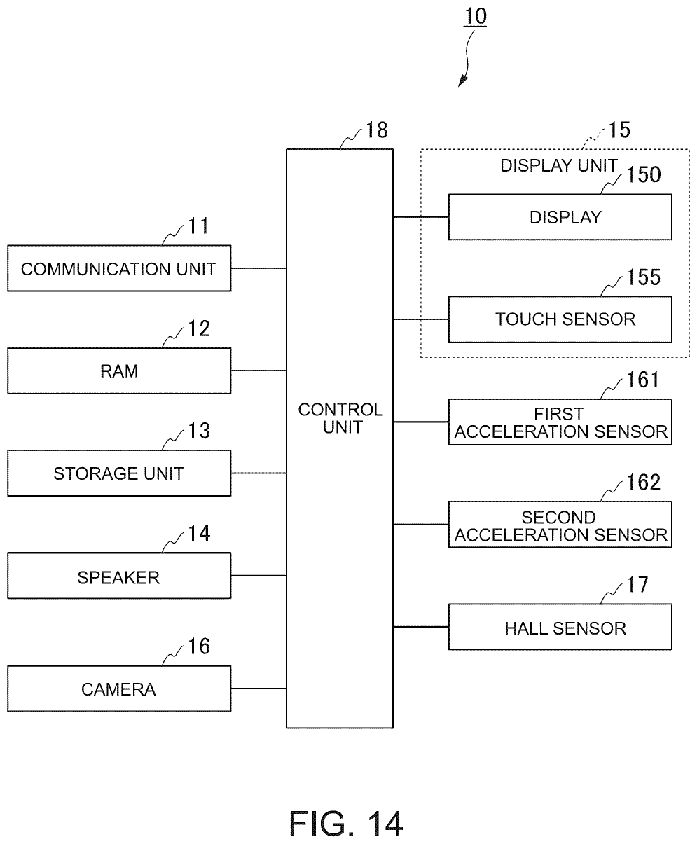

FIG. 14 is a block diagram illustrating an example of the hardware configuration of the information processing apparatus 10 according to the present embodiment. The information processing apparatus 10 includes a communication unit 11, a RAM (Random Access Memory) 12, a storage unit 13, a speaker 14, a display unit 15, the camera 16, a first acceleration sensor 161, a second acceleration sensor 162, a Hall sensor 17, and a control unit 18. These units are communicably connected to one another through buses and the like.

The communication unit 11 is configured to include digital input/output ports such as two or more Ethernet (registered trademark) ports and two or more USB (Universal Serial Bus) ports, communication devices that perform wireless communication such as Bluetooth (registered trademark) and Wi-Fi (registered trademark), and the like. For example, the communication unit 11 can communicate with the above-described external keyboard 30 and the like using Bluetooth (registered trademark).

A program and data for processing executed by the control unit 18 are loaded into the RAM 12, and various data are stored or deleted appropriately. For example, the RAM 12 also functions as a video memory (V-RAM) for displaying data on the display 150. As an example, the RAM 12 functions as a video memory for data to be displayed in each display area when the display 150 is controlled to the one-screen mode, the two-screen mode, or the like. Further, the RAM 12 stores information on running apps, information on an app in use among the running apps (an app of an active window) and inactive windows other than the app in use, information indicating in which of display areas each window is displayed and on which of layers the window is arranged, the size of the window, and whether or not the window is minimized, and the like. Note that since the RAM 12 is a volatile memory, no data is retained when power supply to the RAM 12 is stopped. Data that must be retained when the power supply to the RAM 12 is stopped is transferred to the storage unit 13.

The storage unit 13 is configured to include any one or more of an SSD (Solid State Drive), an HDD (Hard Disk Drive), a ROM (Read Only Memory), a Flash ROM, and the like. For example, in the storage unit 13, a BIOS (Basic Input Output System) program and configuration data, an OS (Operating System), programs of apps running on the OS, various data used in the apps, and the like are stored.

The speaker 14 outputs electronic sound, voice, and the like.

The display unit 15 includes the display 150 and a touch sensor 155. As described above, the display 150 is a flexible display bendable to fit the open angle θ by relative rotation of the first chassis 101 and the second chassis 102. The display 150 provides a display corresponding to each display mode described with reference to FIG. 4 under the control of the control unit 18. The touch sensor 155 is provided on the screen of the display 150 to detect a touch operation on the screen. For example, in the case of the one-screen mode, the touch sensor 155 detects a touch operation in the display area DA. Further, in the case of the two-screen mode, the touch sensor 155 detects a touch operation(s) in either or both of the first display area DA1 and the second display area DA2. A tap operation, a slide operation, a flick operation, a swipe operation, a pinch operation, and the like are included in touch operations. The touch sensor 155 detects a touch operation and outputs, to the control unit 18, operation information based on the detected operation.

The camera 16 is configured to include a lens, an image sensor, and the like. The camera 16 captures images (still images and moving images) and outputs data of the captured images under the control of the control unit 18.

The first acceleration sensor 161 is provided inside the first chassis 101 to detect the orientation of the first chassis 101 and a change in the orientation of the first chassis 101. For example, assuming that a direction parallel to the long-side direction of the first display area DA1 is X1 direction, a direction parallel to the short-side direction is Y1 direction, and a direction perpendicular to the X1 direction and the Y1 direction is Z1 direction, the first acceleration sensor 161 detects respective accelerations along the X1 direction, the Y1 direction, and the Z1 direction, and outputs the detection results to the control unit 18.

The second acceleration sensor 162 is provided inside the second chassis 102 to detect the orientation of the second chassis 102 and a change in the orientation of the second chassis 102. For example, assuming that a direction parallel to the long-side direction of the second display area DA2 is X2 direction, a direction parallel to the short-side direction is Y2 direction, and a direction perpendicular to the X2 direction and the Y2 direction is Z2 direction, the second acceleration sensor 162 detects respective accelerations along the X2 direction, the Y2 direction, and the Z2 direction, and outputs the detection results to the control unit 18.

The Hall sensor 17 is provided to detect the connection of the keyboard 30. For example, when the keyboard 30 is mounted on the second display area DA2 of the second chassis 102, the magnetic field changes by the approach of the magnets provided inside the bottom of the keyboard 30 to change a detection value (output value) of the Hall sensor 17. In other words, the Hall sensor 17 outputs a detection result different depending on whether or not the keyboard 30 is mounted. Note that it is detected whether or not the keyboard 30 is mounted by using the Hall sensor 17 here, but the detection method is not limited thereto, and any other detection method can also be used.

The control unit 18 is configured to include processors such as a CPU (Central Processing Unit), a GPU (Graphic Processing Unit), and a microcomputer to realize various functions by executing programs (the BIOS, the OS, and various programs such as apps running on the OS) stored in the storage unit 13 and the like. For example, the control unit 18 detects the posture (orientation) of the information processing apparatus 10 based on the detection results of the first acceleration sensor 161 and the second acceleration sensor 162. Further, the control unit 18 detects whether the information processing apparatus 10 is in the open state or the closed state, whether the information processing apparatus 10 is in the bent state (Bent form) or the flat state (Flat form) in the case of the open state, and the like based on the detection results of the first acceleration sensor 161 and the second acceleration sensor 162.

Further, the control unit 18 detects a display mode switching operation by the user (for example, an operation on a display mode switching icon illustrated in FIGS. 5A-5C). Further, the control unit 18 detects the connection with the keyboard 30 based on the detection result of the Hall sensor 17. Note that this connection with the keyboard 30 indicates the mounting of the keyboard 30 on the second display area DA2, and does not indicate communication connection. The control unit 18 detects the communication connection with the keyboard 30 using the function of Bluetooth (registered trademark) or the like.

Further, the control unit 18 detects the state of the system, the posture (orientation) of the information processing apparatus 10, whether the information processing apparatus 10 is in the open state or the closed state, and whether the information processing apparatus 10 is in the bent state (Bent form) or the flat state (Flat form) in the case of the open state, the display mode switching operation by the user (see FIGS. 5A-5C), the connection with the keyboard 30, and the like to perform display control of the display 150 as described with reference to FIG. 4, and FIG. 6 to FIG. 13B.

Next, a functional configuration related to display control processing among processing executed by the control unit 18 will be described.

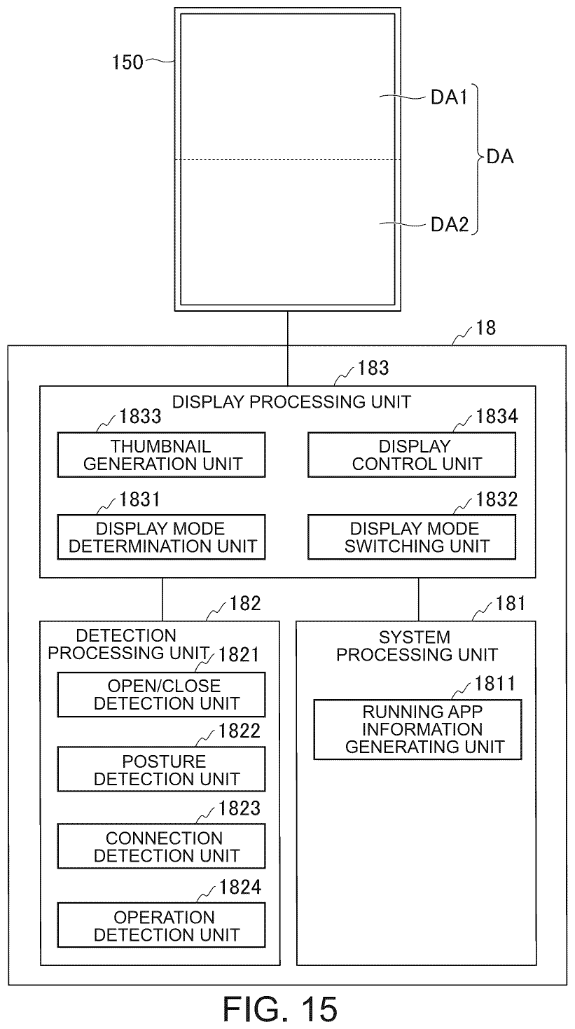

FIG. 15 is a block diagram illustrating an example of the functional configuration related to display control processing according to the present embodiment. The control unit 18 includes a system processing unit 181, a detection processing unit 182, and a display processing unit 183. Here, the system processing unit 181 is a functional component in which the CPU executes processing based, for example, on the OS, the BIOS, or the like. Further, for example, the detection processing unit 182 is a functional component in which the microcomputer, different from the CPU that executes the processing of the OS or the BIOS, executes various detection processes. The display processing unit 183 is a functional component in which the CPU executes processing based, for example, on the OS or a program(s) running on the OS.

The system processing unit 181 executes the OS and various programs such as drivers and apps running on the OS. Further, for example, the system processing unit 181 includes a running app information generating unit 1811. The running app information generating unit 1811 generates app information including identification information on running apps (for example, app IDs), information indicative of an app in use by the user among the running apps (i.e., an app whose window is active), and the like. Further, the running app information generating unit 1811 generates window information indicative of the state of each of windows of the running apps. The state of the window is whether or not the window is an active window, the size (minimized or maximized) of the window, and the like. The running app information generating unit 1811 stores and retains the generated app information and window information in the RAM 12.

The detection processing unit 182 includes an open/close detection unit 1821, a posture detection unit 1822, and a connection detection unit 1823 as functional components to detect the state of the information processing apparatus 10. The detection processing unit 182 outputs, to the display processing unit 183, the detection results by the open/close detection unit 1821, the posture detection unit 1822, and the connection detection unit 1823.

The open/close detection unit 1821 detects whether the information processing apparatus 10 is in the open state or the closed state based on the detection results of the first acceleration sensor 161 and the second acceleration sensor 162. Further, when the information processing apparatus 10 is in the open state, the open/close detection unit 1821 detects the open angle θ between the first chassis 101 and the second chassis 102 based on the detection results of the first acceleration sensor 161 and the second acceleration sensor 162. Then, based on the detected open angle θ, the open/close detection unit 1821 detects whether the information processing apparatus 10 is in the bent state (Bent form) or the flat state (Flat form).

The posture detection unit 1822 detects the posture (orientation) of the information processing apparatus 10 based on the detection results of the first acceleration sensor 161 and the second acceleration sensor 162.

The connection detection unit 1823 detects the connection with the keyboard 30. For example, the connection detection unit 1823 detects whether or not the keyboard 30 is mounted on the second display area DA2 based on the detection result of the Hall sensor 17 to detect the connection with the keyboard 30. The detection processing unit 182 outputs, to the display processing unit 183, the detection results by the open/close detection unit 1821, the posture detection unit 1822, and the connection detection unit 1823 (that is, the state of the information processing apparatus 10).

Further, the detection processing unit 182 includes an operation detection unit 1824 as a functional component to detect an operation on the information processing apparatus 10. The operation detection unit 1824 detects a user operation based on operation information output from the touch sensor 155 provided on the screen of the display 150. For example, the operation detection unit 1824 acquires operation information based on a user operation on the switching menu screen (see FIGS. 5A-5C, FIG. 9, or FIG. 11) to enable an operation for switching the display mode or a thumbnail display operation, and detects a display mode switching operation to switch the display mode or a thumbnail display operation by the user based on the acquired operation information. The detection processing unit 182 outputs the detected user operation information to the display processing unit 183.

Based on the open/closed state and the posture (orientation) of the information processing apparatus 10, the user operation, and the like acquired from the detection processing unit 182, the display processing unit 183 determines a display mode and switches to the display mode. Further, based on the app information acquired from the system processing unit 181, the display processing unit 183 controls the display of windows of running apps (an active window and inactive windows) depending on the display mode and the like. Specifically, the display processing unit 183 includes a display mode determination unit 1831, a display mode switching unit 1832, a thumbnail generation unit 1833, and a display control unit 1834.

The display mode determination unit 1831 performs determination processing to determine a display mode based on the detection result of the state of the information processing apparatus 10 or the user operation detected by the detection processing unit 182. For example, the display mode determination unit 1831 acquires, from the detection processing unit 182, the detection result of the open/closed state of the information processing apparatus 10, the detection result of whether the information processing apparatus 10 is in the bent state (Bent form) or the flat state (Flat form) in the case of the open state, the detection result of the posture (orientation) of the information processing apparatus 10, and the user operation information. Then, the display mode determination unit 1831 determines a display mode described with reference to FIG. 4 based on the respective detection results and the operation information acquired from the detection processing unit 182.

The display mode switching unit 1832 performs display mode switching processing to switch to a display mode as described with reference to FIG. 4 based on the display mode determined by the display mode determination unit 1831. For example, based on the display mode determined by the display mode determination unit 1831, the display mode switching unit 1832 switches among the one-screen mode, the two-screen mode (or the reversed two-screen mode), the half-screen mode, and the like, and sets a display mode such as the orientation of each display area and the display content of each display area.

The thumbnail generation unit 1833 generates thumbnail images corresponding to windows of running apps. For example, the thumbnail generation unit 1833 generates thumbnail images corresponding to inactive windows among windows of running apps as thumbnail images to be displayed as a thumbnail window in the second display area DA2 when switching from the one-screen mode to the two-screen mode. Further, for example, the thumbnail generation unit 1833 generates thumbnail images corresponding to windows of running apps as thumbnail images to be displayed as a thumbnail window in a display area specified by a thumbnail display operation. Note that the thumbnail generation unit 1833 basically generates thumbnail images by including a minimized window as an inactive window.

The display control unit 1834 performs display control processing according to the display mode set by the display mode switching unit 1832 to output display data of a window of an app to be displayed in each display area and a thumbnail window in order to display the window of the app and the thumbnail window.

For example, when switching from the one-screen mode to the two-screen mode by the display mode switching unit 1832, the display control unit 1834 displays, in the first display area DA1, an active window (an active window that was displayed in the display area DA) among windows of apps running in the one-screen mode.

Further, when switching from the one-screen mode to the two-screen mode by the display mode switching unit 1832, the display control unit 1834 controls whether or not to display, in the second display area DA2, thumbnail images corresponding to inactive windows except the active window in the one-screen mode based on the number of windows in the one-screen mode. For example, when the number of windows in the one-screen mode is more than two (more than the number of display areas in the two-screen mode), the display control unit 1834 displays, in the second display area DA2, a thumbnail window in which thumbnail images of inactive windows in the one-screen mode are lined up upon switching to the two-screen mode (see FIGS. 7A-7B).

On the other hand, when the number of windows in the one-screen mode is two or less (equal to or less than the number of display areas in the two-screen mode), the display control unit 1834 does not display any thumbnail window in the second display area DA2 when switching to the two-screen mode. For example, when the number of windows in the one-screen mode is two, the display control unit 1834 displays, in the second display area DA2, an inactive window in the one-screen mode (see FIGS. 8A-8B). Note that, when the number of windows in the one-screen mode is one or less, the display control unit 1834 displays, in the second display area DA2, neither a window of an app nor a thumbnail window (a thumbnail image of the window) when switching to the two-screen mode.

Note that the display control unit 1834 may not include, in the number of windows in the one-screen mode, a window minimized upon switching from the one-screen mode to the two-screen mode by the display mode switching unit 1832.

Further, when any one of thumbnail images being displayed in the second display area DA2 is selected in the two-screen mode, the display control unit 1834 displays an inactive window corresponding to the selected thumbnail image in the second display area DA2 as an active window. For example, the display control unit 1834 maximizes and displays the inactive window corresponding to the selected thumbnail image in the second display area DA2 as the active window.

Further, when a thumbnail display operation by the user is detected by the detection processing unit 182, the display control unit 1834 displays a thumbnail window in a display area specified by the thumbnail display operation based on the operation information acquired from the detection processing unit 182.

For example, the display control unit 1834 displays, in a thumbnail window to be displayed when switching from the one-screen mode to the two-screen mode, thumbnail images corresponding to inactive windows except the active window in the one-screen mode, but when displaying the thumbnail window due to the fact that the thumbnail display operation is detected, the display control unit 1834 displays not only the thumbnail images corresponding to the inactive windows but also a thumbnail image corresponding to the active window (for example, the active window in the one-screen mode).

Further, for example, after performing control to hide the thumbnail window displayed in the second display area DA2 upon switching from the one-screen mode to the two-screen mode, the display control unit 1834 displays the thumbnail window in a display area specified by a thumbnail display operation due to the fact that the thumbnail display operation is detected. In other words, the display control unit 1834 can redisplay the thumbnail window in any display area by the thumbnail display operation after the thumbnail window is hidden.

### (Operation of Thumbnail Window Display Control Processing)

Next, the operation of display control processing in which the control unit 18 controls whether or not to display a thumbnail window when switching from the one-screen mode to the two-screen mode will be described.

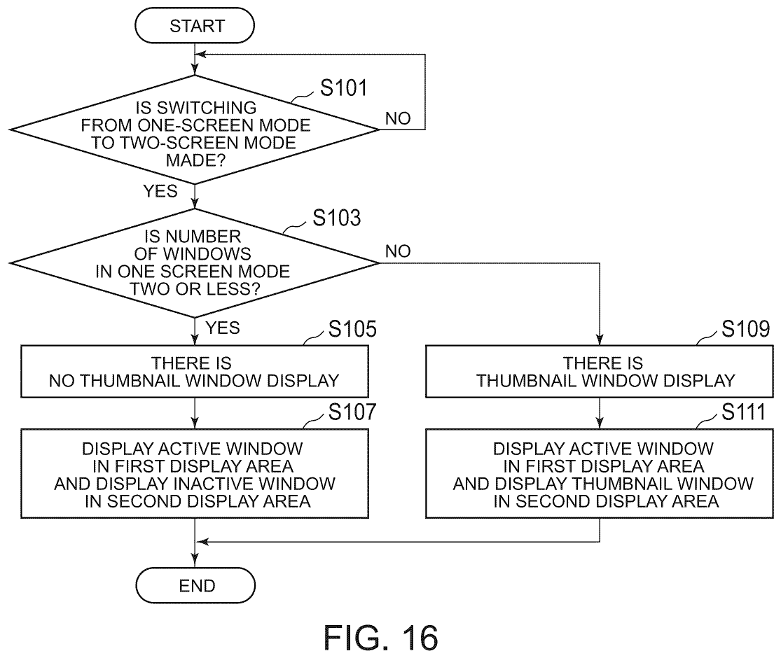

FIG. 16 is a flowchart illustrating an example of thumbnail window display control processing upon switching between screen modes according to the present embodiment.

(Step S101) The control unit 18 determines whether or not to switch from the one-screen mode to the two-screen mode. For example, the control unit 18 determines whether or not to switch from the one-screen mode to the two-screen mode by detecting a change from the flat state (Flat form) to the bent state (Bent form) as described with reference to FIG. 4 or based on display mode switching operations described with reference to FIGS. 5A-5C. When determining that switching from the one-screen mode to the two-screen mode is not made (NO), the control unit 18 continues the one-screen mode, and performs the process in step S101 again. On the other hand, when determining that switching from the one-screen mode to the two-screen mode is made (YES), the control unit 18 switches to the two-screen mode in which the display area DA is split into two display areas of the first display area DA1 and the second display area DA2, and proceeds to a process in step S103.

(Step S103) The control unit 18 determines whether or not the number of windows in the one-screen mode before switching to the two-screen mode is two or less. When determining that the number of windows in the one-screen mode is two or less (YES), the control unit 18 proceeds to a process in step S105. On the other hand, when determining that the number of windows in the one-screen mode is more than two (NO), the control unit 18 proceeds to a process in step S109.

(Step S105) The control unit 18 sets that there is no thumbnail window display upon switching to the two-screen mode, and proceeds to a process in step S107.

(Step S107) The control unit 18 displays, in the first display area DA1, an active window in the one-screen mode, and displays, in the second display area DA2, an inactive window in the one-screen mode (see FIGS. 8A-8B). Note that, when the number of windows in the one-screen mode is one, the control unit 18 displays neither a window of an app nor a thumbnail window in the second display area DA2.

(Step S109) The control unit 18 sets that there is thumbnail window display upon switching to the two-screen mode, and proceeds to a process in step S111.

(Step S111) The control unit 18 displays, in the first display area DA1, an active window in the one-screen mode, and displays, in the second display area DA2, a thumbnail window in which thumbnail images of inactive windows in the one-screen mode are lined up (see FIGS. 7A-7B).

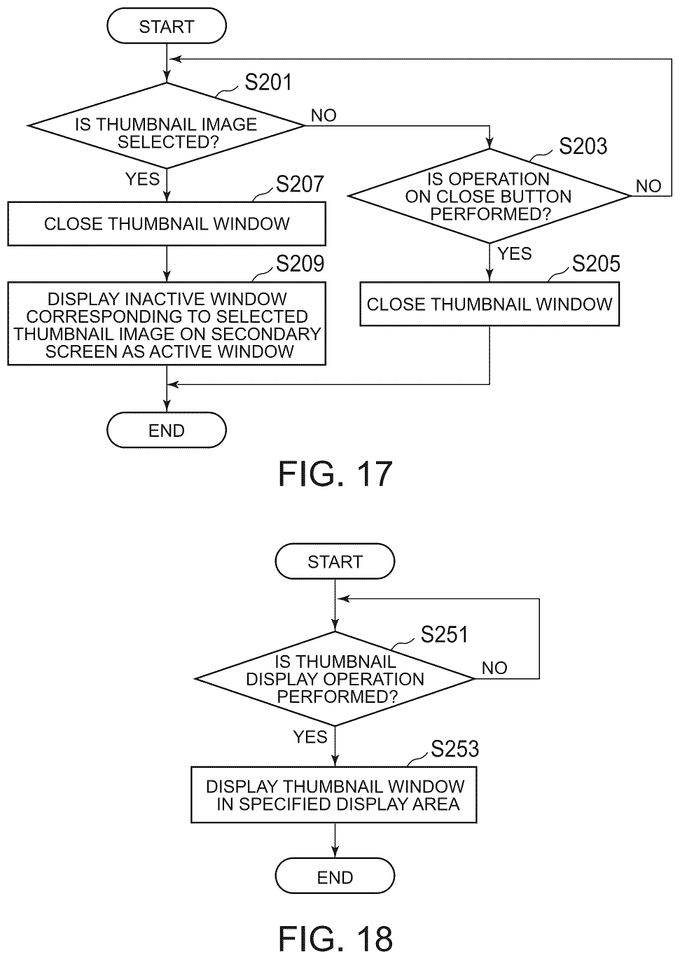

Next, the operation of display control processing when a thumbnail image is selected after the thumbnail window is displayed in the second display area DA2 in step S111 of FIG. 16 will be described. FIG. 17 is a flowchart illustrating an example of display control processing when a thumbnail image is selected according to the present embodiment.

(Step S201) The control unit 18 determines whether or not any one of thumbnail images being displayed in the second display area DA2 is selected. When determining that no thumbnail image is selected (NO), the control unit 18 proceeds to a process in step S203. On the other hand, when determining that any one of thumbnail images is selected (YES), the control unit 18 proceeds to a process in step S207.

(Step S203) The control unit 18 determines whether or not an operation on the close button “x” displayed on the title bar B1 of the thumbnail window displayed in the second display area DA2 (the secondary screen) (see FIG. 6) is performed. When determining that an operation on the close button “x” is performed (YES), the control unit 18 proceeds to a process in step S205. On the other hand, when determining that any operation on the close button “x” is not performed (NO), the control unit 18 returns to the process in step S201.

(Step S205) When determining in step S203 that the operation on the close button “x” is performed, the control unit 18 closes and hides the thumbnail window to end the display of the thumbnail window.

(Step S207) When determining in step S201 that any one of the thumbnail images is selected, the control unit 18 closes the thumbnail window and proceeds to a process in step S209.

(Step S209) The control unit 18 displays a window corresponding to the selected thumbnail image in the second display area DA2 as an active window (for example, maximizes and displays the window in the second display area DA2).

Next, the operation of display control processing to display a thumbnail window in any display area by a thumbnail display operation will be described.

FIG. 18 is a flowchart illustrating an example of thumbnail window display control processing by a thumbnail display operation according to the present embodiment.

(Step S251) The control unit 18 determines whether or not a thumbnail display operation (see FIG. 9 or FIG. 11) is performed based on the operation information acquired from the detection processing unit 182. When determining that no thumbnail display operation is performed (NO), the control unit 18 performs the process in step S251 again. On the other hand, when determining that a thumbnail display operation is performed (YES), the control unit 18 proceeds to a process in step S253.

(Step S253) The control unit 18 displays a thumbnail window in a display area specified by the thumbnail display operation (see FIG. 10B, FIG. 12B, or FIG. 13B). For example, the control unit 18 displays, in the thumbnail window, not only thumbnail images corresponding to inactive windows but also a thumbnail image corresponding to the active window in a lined-up manner.

As described above, the information processing apparatus 10 according to the present embodiment includes: the display 150; the storage unit 13 (an example of a memory) which stores a program of an app (application); and the control unit 18 (an example of a processor such as the CPU, the GPU, or the microcomputer) which executes the program of the app stored in the storage unit 13 to perform control to display a window of the app on the display 150. The control unit 18 performs display mode switching processing to control switching between the one-screen mode (an example of a first display mode) to control display using the entire screen area of the display 150 as one display area DA, and the two-screen mode (an example of a second display mode) to control display by splitting the screen area of the display 150 into two display areas (for example, into the first display area DA1 and the second display area DA2). Further, the control unit 18 performs first display control processing in which, when switching from the one-screen mode to the two-screen mode by the display mode switching processing, the control unit 18 displays, in the first display area DA1 among two or more display areas, an active window (an example of one window) among windows of apps running in the one-screen mode, and displays, in the second display area DA2, thumbnail images corresponding to windows (for example, inactive windows) except the active window among the windows in the one-screen mode, and second display control processing to display the thumbnail images in a display area specified by a thumbnail display operation (an example of a predetermined operation) among display areas inside the screen area of the display 150 due to the fact that the thumbnail display operation by the user is detected.

Thus, since the information processing apparatus 10 can display the thumbnail images of the windows of the running apps in any display area according to the user operation, operability when selecting windows to be displayed, respectively, in two or more display areas can be improved.

For example, in the second display control processing, when displaying the thumbnail images due to the fact that the thumbnail display operation is detected, the control unit 18 also displays a thumbnail image corresponding to the active window among the windows in the one-screen mode.

Thus, when displaying all the thumbnail images of the windows of the running apps according to the user operation rather than switching between the screen modes, since the information processing apparatus 10 displays all the thumbnail images of the windows of the running apps rather than only the thumbnail images of the inactive windows, the user can select a window of an app that the user wants to display from among all the running apps.

For example, the control unit 18 displays, in the screen area of the display 150, the display mode switching icon C22 (an example of a first icon) for accepting a user operation to switch from the one-screen mode to the two-screen mode. Then, when the user operation on the display mode switching icon C22 is detected in the one-screen mode, the control unit 18 switches from the one-screen mode to the two-screen mode. On the other hand, in the two-screen mode, when accepting a user operation on the display mode switching icon C22 as a thumbnail display operation and the operation on the display mode switching icon C22 is detected, the control unit 18 determines that the thumbnail display operation is detected, and displays thumbnail images. Note that, like the display mode switching icon C22, the display mode switching icons C12, C13, and C23 also accept user operations as thumbnail display operations in the two-screen mode.

Thus, since an icon operated for switching between screen modes and an icon operated for displaying thumbnail images of windows of running apps are common to each other, the information processing apparatus 10 can improve operability.

Further, after thumbnail images displayed in the second display area DA2 are controlled to be hidden in the second display control processing, the control unit 18 displays the thumbnail images in a display area specified by a thumbnail display operation due to the fact that the thumbnail display operation is detected.

Thus, since the information processing apparatus 10 can redisplay the thumbnail images of the windows of the running apps in any display area according to the user operation, operability when selecting windows to be displayed, respectively, in two or more display areas can be improved.

For example, when any one of the thumbnail images displayed in the second display area DA2 is selected with a user operation, the control unit 18 hides all the thumbnail images displayed in the second display area DA2, and displays a window corresponding to the selected thumbnail image. For example, the control unit 18 maximizes and displays the window corresponding to the selected thumbnail image in the second display area DA2 as an active window.

Thus, when the user wants to change the window currently in use to another window, since the information processing apparatus 10 can allow the user to easily select the other window from among the thumbnail images, it is convenient.

Further, when a user operation for hiding the thumbnail images displayed in the second display area DA2 is performed, the control unit 18 hides all the thumbnail images displayed in the second display area DA2. Note that the user operation for hiding the thumbnail images is, for example, an operation on the close button “x” displayed on the title bar B1 of the thumbnail window (see FIG. 6).

Thus, when the user wants to hide the thumbnail window (the thumbnail images), the information processing apparatus 10 can hide the thumbnail window (the thumbnail images) with an easy operation. Otherwise, the information processing apparatus 10 may close and hide the thumbnail window when a user operation (for example, a tap operation) is performed in an area in which no thumbnail image of the thumbnail window exists or in an area with no thumbnail image displayed therein (in an area in which a window of an app is already arranged).

Note that, when switching from the one-screen mode to the two-screen mode by the display mode switching processing, the control unit 18 may also control whether or not to display, in the second display area DA2, a thumbnail window (thumbnail images) in the first display control processing based on the number of windows in the one-screen mode.

In such a case, when switching from the one-screen mode to the two-screen mode, since the information processing apparatus 10 displays the active window in the one-screen mode before switching, and controls whether or not to display thumbnail images of inactive windows in a listable manner based on the number of windows in the one-screen mode, the display when switching from the one-screen mode to the two-screen mode can be controlled properly.

For example, in the case where switching from the one-screen mode to the two-screen mode is made by the display mode switching processing, when the number of windows in the one-screen mode is two or less (equal to or less than the number of display areas in the two-screen mode), the control unit 18 displays, in the second display area DA2, a window except the active window between the windows in the one-screen mode without displaying any thumbnail window (any thumbnail image). On the other hand, in the case where switching from the one-screen mode to the two-screen mode is made by the display mode switching processing, when the number of windows in the one-screen mode is more than two (more than the number of display areas in the two-screen mode), the control unit 18 displays a thumbnail window (thumbnail images) in the second display area DA2.

Thus, in the case where switching from the one-screen mode to the two-screen mode is made, when the number of windows in the one-screen mode before switching is two or less, since the information processing apparatus 10 can display the windows in the one-screen mode respectively using the two display areas in the two-screen mode without deliberately displaying a thumbnail image to require the user to perform an operation to select the thumbnail image, it is convenient. Therefore, the information processing apparatus 10 can properly control the display when switching from the one-screen mode to the two-screen mode.

Further, a control method for the information processing apparatus 10 according to the present embodiment includes: a display mode switching step of causing the control unit 18 to control switching between the one-screen mode (the example of the first display mode) to control display using the entire screen area of the display 150 as one display area DA, and the two-screen mode (the example of the second display mode) to control display by splitting the screen area of the display 150 into two display areas (for example, into the first display area DA1 and the second display area DA2); a first display control step in which, when switching from the one-screen mode to the two-screen mode by the display mode switching step, the control unit 18 displays, in the first display area DA1 among two or more display areas, an active window (the example of the one window) among windows of apps running in the one-screen mode, and displays, in the second display area DA2, thumbnail images corresponding to windows (for example, inactive windows) except the active window among the windows in the one-screen mode; and a second display control step of causing the control unit 18 to display the thumbnail images in a display area specified by a thumbnail display operation (the example of the predetermined operation) among display areas inside the screen area of the display 150 due to the fact that the thumbnail display operation by the user is detected.

Thus, since the information processing apparatus 10 can display the thumbnail images of the windows of the running apps in any display area according to the user operation, operability when selecting windows to be displayed, respectively, in two or more display areas can be improved.

### Second Embodiment

Next, an overview of a second embodiment of the present invention will be described. In the first embodiment, the example in which a display mode switching icon is made to also function as an operating element for accepting a thumbnail display operation is described, but in this embodiment, an example in which an icon as an operating element for accepting a thumbnail display operation is displayed separately from the display mode switching icon will be described.

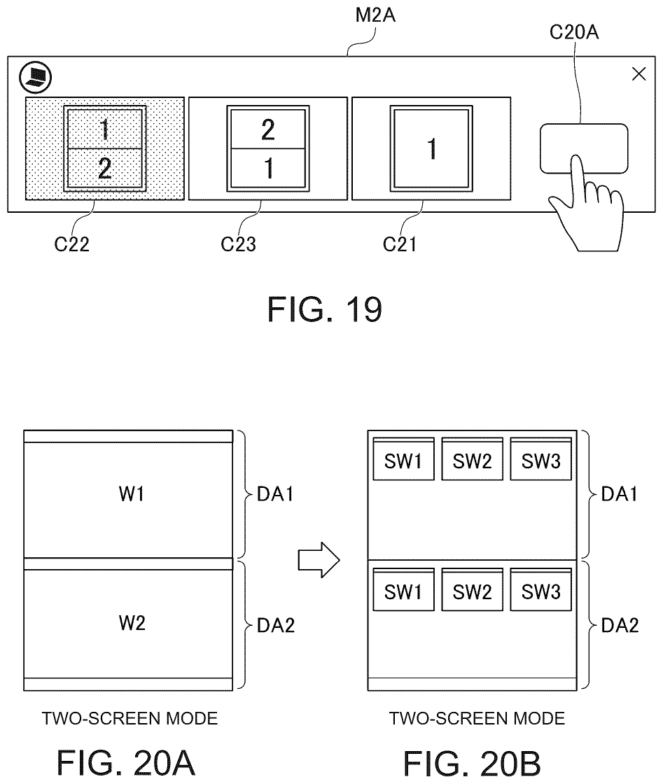

FIG. 19 is a diagram illustrating a first example of a thumbnail display operation according to the present embodiment. A switching menu M2A illustrated in FIG. 19 corresponds to the switching menu M2 illustrated in FIG. 5C but it is different in that a thumbnail display icon C20A is displayed. The thumbnail display icon C20A functions as an operating element for accepting a thumbnail display operation. For example, when a user operation is performed on this thumbnail display icon C20A, thumbnail windows are displayed in all display areas.

FIGS. 20A-20B are diagrams illustrating a first example of display control by a thumbnail display operation according to the present embodiment. Like FIG. 10A and FIG. 12A, FIG. 20A illustrates an example in which the window W1 is maximized and displayed in the first display area DA1 and the window W2 is maximized and displayed in the second display area DA2, respectively, in the two-screen mode. In this display state illustrated in FIG. 20A, when the user performs an operation on the thumbnail display icon C20A illustrated in FIG. 19, thumbnail windows are displayed in the first display area DA1 and the second display area DA2 as illustrated in FIG. 20B. At this time, all the thumbnail images of the windows of the running apps are displayed in the thumbnail windows. For example, in the case where the number of windows of running apps is three (the windows W1, W2, and W3), when the thumbnail display operation is performed, three thumbnail images (thumbnail images SW1, SW2, and SW3) are displayed in the respective thumbnail windows of the first display area DA1 and the second display area DA2 as illustrated in FIG. 20B.

Note that the example in which the thumbnail windows (thumbnail images) are displayed, respectively, in all the display areas (the first display area DA1 and the second display area DA2) inside the screen area of the display 150 when the thumbnail display operation is performed on the thumbnail display icon C20A is described here, but a thumbnail window (thumbnail images) may also be displayed in a preset one display area (for example, in the second display area DA2).

Further, when an icon as an operating element for accepting a thumbnail display operation is displayed separately from display mode switching icons, an area in which thumbnail images are to be displayed may be able to be specified (selected).

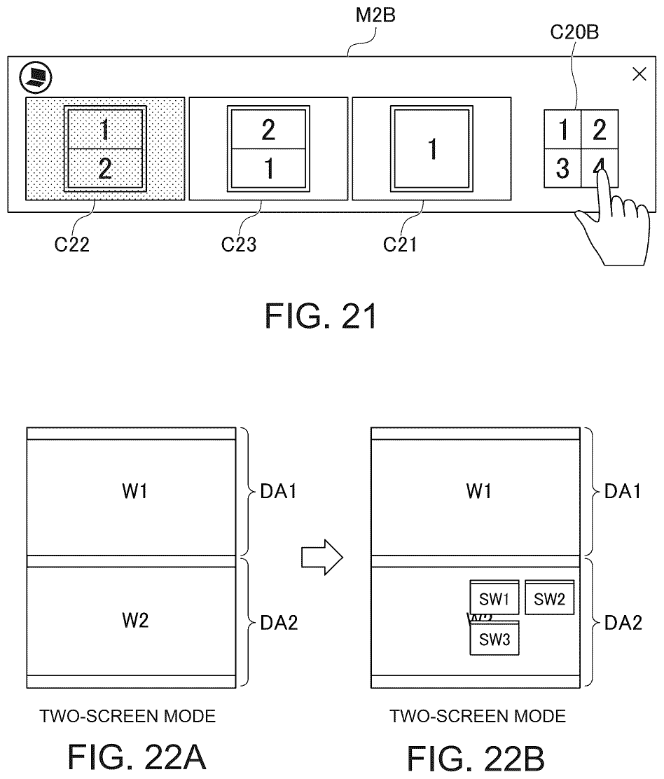

FIG. 21 is a diagram illustrating a second example of a thumbnail display operation according to the present embodiment. A switching menu M2B illustrated in FIG. 21 corresponds to the switching menu M2 illustrated in FIG. 5C but it is different in that a thumbnail display icon C20B is displayed. The thumbnail display icon C20B functions as an operating element for accepting a thumbnail display operation.

Unlike the thumbnail display icon C20A, split areas obtained by splitting the screen area of the display 150 into multiple split areas are displayed in the thumbnail display icon C20B. In the illustrated example, split areas obtained by splitting the screen area of the display 150 into four areas of “1,” “2,” “3,” and “4” are displayed in the thumbnail display icon C20B. The user can specify (select) an area in which thumbnail images are to be displayed from among the four split areas. Note that the split areas are areas for specifying an area in which thumbnail images are to be displayed, which is not related to switching between the screen modes. In other words, the four split areas are illustrated, but it does not mean the four-screen mode. For example, in the case of the two-screen mode, thumbnail images are displayed in a specified split area while remaining in the two-screen mode. An example of display control to display thumbnail images by the user performing an operation to select the split area indicated by “4” on the thumbnail display icon C20B is illustrated in FIGS. 22A-22B.

FIGS. 22A-22B are diagrams illustrating a second example of display control by the thumbnail display operation according to the present embodiment. Like FIG. 20A, FIG. 22A illustrates an example in which the window W1 is maximized and displayed in the first display area DA1 and the window W2 is maximized and displayed in the second display area DA2, respectively, in the two-screen mode. In this display state illustrated in FIG. 22A, when the user performs the operation on the split area indicated by “4” of the thumbnail display icon C20B illustrated in FIG. 21, the thumbnail images (the thumbnail images SW1, SW2, and SW3) are displayed in an area corresponding to the split area indicated by “4” inside the second display area DA2 while remaining in the two-screen mode as illustrated in FIG. 22B. At this time, the thumbnail images are displayed in such a manner that the thumbnail images are superimposed on the window W2 being displayed in the second display area DA2 (displayed on a layer upper than that of the window W2). Note that the thumbnail images may be superimposed as a thumbnail window, or the thumbnail images themselves may be superimposed and displayed rather than in the form of a thumbnail window.

Note that thumbnail display operations when the usage form is “Clamshell” or “Portrait” (the display mode (c-1), the display mode (e), the display mode (e′), or the like) are described with reference to FIG. 19 to FIG. 22B, but when the usage form is “Landscape” (the display mode (b), the display mode (d), the display mode (d′), or the like), thumbnail display operations can also be performed in the same way by displaying an icon corresponding to the thumbnail display icon C20A or the thumbnail display icon C20B on the switching menu M1 illustrated in FIGS. 5A-5C. Further, the thumbnail display icon may be displayed separately from the switching menu.

Thus, in the information processing apparatus 10 according to the present embodiment, the control unit 18 displays, in the screen area of the display 150, the thumbnail display icon C20A or C20B (an example of a second icon) for accepting a thumbnail display operation (the example of the predetermined operation) separately from the display mode switching icon (the example of the first icon) for accepting a user operation to switch from the one-screen mode to the two-screen mode. Then, when the operation on the thumbnail display icon C20A or C20B is detected, the control unit 18 determines that the thumbnail display operation is detected and displays thumbnail images.

Thus, since the information processing apparatus 10 can display the thumbnail images of windows of running apps in any of the two or more display areas with an easy operation, operability when selecting windows to be displayed, respectively, in the two or more display areas can be improved.

For example, the thumbnail display icon C20B accepts an operation to specify a display area (for example, a split area) in which thumbnail images are to be displayed from among multiple display areas split in the two-screen mode despite the two display areas (the first display area DA1 and the second display area DA2) in the two-screen mode.

Thus, since the information processing apparatus 10 can display the thumbnail images of the windows of the running apps in any display area according to the user operation, operability when selecting windows to be displayed, respectively, in the two or more display areas can be improved.

Note that the example of being able to specify, from among the four split areas, an area in which thumbnail images are to be displayed is described in FIG. 21 and FIGS. 22A-22B, but the number of split areas is not limited to four, and it may be two or three, or five or more.

### Third Embodiment

Next, an overview of a third embodiment of the present invention will be described.

In the first embodiment, such a configuration that the information processing apparatus 10 has the one-screen mode to control display using the entire screen area of the display 150 as one display area DA, and the two-screen mode to control display by splitting the screen area of the display 150 into two display areas of the first display area DA1 and the second display area DA2 is described, but the information processing apparatus 10 may also control display by splitting the screen area of the display 150 into three or more display areas.

In this embodiment, in addition to the one-screen mode and the two-screen mode, the information processing apparatus 10 has a three-screen mode to control display by splitting the screen area of the display 150 into three display areas, and a four-screen mode to control display by splitting the screen area of the display 150 into four display areas. In the following, display control when switching from the one-screen mode to the three-screen mode, and display control when switching from the one-screen mode to the four-screen mode will be described.

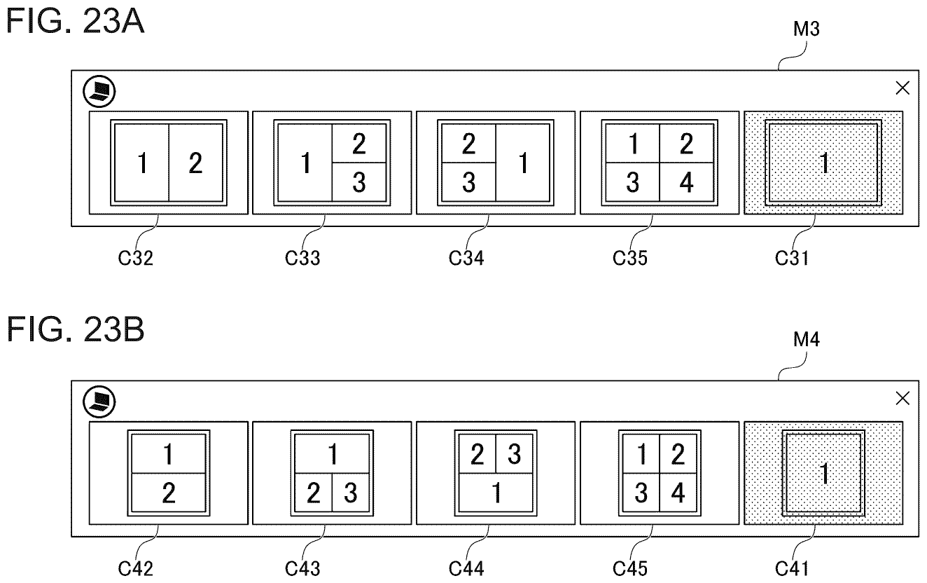

FIGS. 23A-23B are diagrams illustrating an example of operation specifications of display mode switching operations according to the present embodiment. FIGS. 23A-23B illustrate an example of switching menus displayed by performing, for example, the operation on the icon C1 illustrated in FIG. 5A. FIG. 23A illustrates a switching menu M3 displayed when the usage form is “Landscape” (the display mode (b), the display mode (d), the display mode (d′), or the like), and FIG. 23B illustrates a switching menu M4 when the usage form is “Clamshell” or “Portrait” (the display mode (c-1), the display mode (e), the display mode (e′), or the like). The switching menu M3 and the switching menu M4 are different respectively from the switching menu M1 in FIG. 5B and the switching menu M2 in FIG. 5C in that the switching menu M3 and the switching menu M4 can switch to the three-screen mode and the four-screen mode.

On the switching menu M3, display mode switching icons C31, C32, C33, C34, and C35 are displayed. The display mode switching icon C31 is displayed as an operating element for selecting the display mode (d) or the display mode (d′) in the one-screen mode. The display mode switching icon C32 is displayed as an operating element for selecting the display mode (b) in the two-screen mode. The display mode switching icon C33 and the display mode switching icon C34 are displayed as operating elements for selecting display modes in the three-screen mode, respectively. The display mode switching icon C33 and the display mode switching icon C34 are different in whether the first display area DA1 or the second display area DA2 in the two-screen mode is split into two display areas. The display mode switching icon C35 is displayed as an operating element for selecting a display mode in the four-screen mode.

Like in FIGS. 5A-5C, “1,” “2,” “3,” and “4” in FIGS. 23A-23B are affixed to distinguish among the display areas, which are numbers, for example, according to the area priority preset for respective display areas. “1” is the highest area priority, and the area priority goes down in the order of “2,” “3,” and “4.”

When the user performs an operation to select the display mode switching icon C33 or the display mode switching icon C34, the display of the switching menu is ended, and control is made to the three-screen mode in “Landscape.” Further, when the user performs an operation to select the display mode switching icon C35, the display of the switching menu is ended, and control is made to the four-screen mode in “Landscape.”

On the switching menu M4, display mode switching icons C41, C42, C43, C44, and C45 are displayed. The display mode switching icon C41 is displayed as an operating element for selecting the display mode (e) or the display mode (e′) in the one-screen mode. The display mode switching icon C42 is displayed as an operating element for selecting the display mode (c-1) in the two-screen mode. The display mode switching icon C43 and the display mode switching icon C44 are displayed as operating elements for selecting display modes in the three-screen mode, respectively. The display mode switching icon C43 and the display mode switching icon C44 are different in whether the first display area DA1 or the second display area DA2 in the two-screen mode is split into two display areas. The display mode switching icon C45 is displayed as an operating element for selecting a display mode in the four-screen mode.

When the user performs an operation to select the display mode switching icon C43 or the display mode switching icon C44, the display of the switching menu is ended, and control is made to the three-screen mode in “Clamshell” or “Portrait.” Further, when the user performs an operation to select the display mode switching icon C45, the display of the switching menu is ended, and control is made to the four-screen mode in “Clamshell” or “Portrait.”

(Display Control upon Switching from One-screen Mode to Three-screen Mode)

Next, display control upon switching from the one-screen mode to the three-screen mode will be described. Here, respective areas when the screen area of the display 150 is split into three display areas in the three-screen mode are called a first display area DA1, a second display area DA2, and a third display area DA3.

In the case of the three-screen mode in which the side of the second display area DA2 in the two-screen mode is split into two display areas, the first display area DA1 corresponds to the first display area DA1 in the two-screen mode, and the second display area DA2 and the third display area DA3 correspond to respective display areas obtained by splitting the second display area DA2 in the two-screen mode into two. Here, it can also be said that the second display area DA2 and the third display area DA3 in the three-screen mode are two second display areas obtained by splitting the display area except the first display area DA1 (for example, the second display area DA2 in the two-screen mode) into two display areas. In order to distinguish between the two second display areas, one second display area with higher area priority is illustrated as the second display area DA2, and the other second display area is illustrated as the third display area DA3. In other words, the area priority order in the three-screen mode is the first display area DA1, the second display area DA2, and the third display area DA3 from top to bottom.

Note that, in the case of the three-screen mode in which the side of the first display area DA1 in the two-screen mode is split into two display areas, this three-screen mode is different from the three-screen mode in which the side of the second display area DA2 in the two-screen mode is split into two display areas only in the side of the display area split into two display areas.

As described in the first embodiment, in the case where switching from the one-screen mode to the two-screen mode is made, when the number of windows in the one-screen mode is more than two, the information processing apparatus 10 displays a thumbnail window in the second display area DA2, while when the number of windows is two or less, the information processing apparatus 10 does not display any thumbnail window. On the contrary, in the case where switching from the one-screen mode to the three-screen mode is made, when the number of windows in the one-screen mode is more than three, the information processing apparatus 10 displays a thumbnail window in the second display area DA2, while when the number of windows is three or less, the information processing apparatus 10 does not display any thumbnail window.

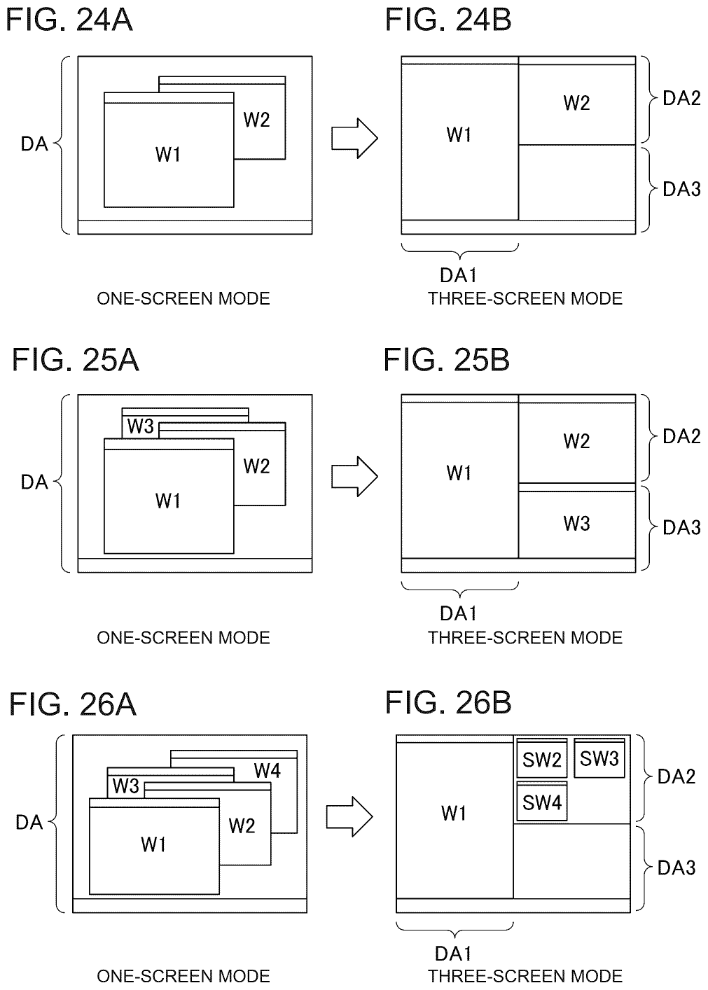

In the following, a display control example of switching to the three-screen mode in which an operation to select, for example, the display mode switching icon C33 in FIG. 23A is performed in the one-screen mode in “Landscape” (the display mode (d) or the display mode (d′)) to split the side of the second display area DA2 in the two-screen mode into the two display areas will be described with reference to FIG. 24A to FIG. 26B.

FIGS. 24A-24B are diagrams illustrating a first example of display control upon switching from the one-screen mode to the three-screen mode according to the present embodiment. FIG. 24A illustrates a display example of the one-screen mode, and FIG. 24B illustrates a display example after switching to the three-screen mode. In the illustrated example, the number of windows of apps running in the one-screen mode is two. Here, two windows W1 and W2 are illustrated in the display area DA. The window W1 is an active window arranged on the frontmost layer (the top layer).

When switching from the one-screen mode to the three-screen mode, the window W1 is maximized and displayed in the first display area DA1 as the active window and the window W2 is maximized and displayed in the second display area DA2 as an inactive window according to the area priority and the window priority. Since there is no window to be displayed in the third display area DA3 (since there is no window in the third priority), the third display area DA3 is put into such a state that the desktop screen is displayed without displaying any window.

Note that, when the number of windows of apps running in the one-screen mode is one (only the window W1), the window W1 is maximized and displayed in the first display area DA1 as the active window, but the second display area DA2 and the third display area DA3 are put into such a state that the desktop screen is displayed without displaying any window because of no window to be displayed.

FIGS. 25A-25B are diagrams illustrating a second example of display control upon switching from the one-screen mode to the three-screen mode according to the present embodiment. FIG. 25A illustrates a display example of the one-screen mode, and FIG. 25B illustrates a display example after switching to the three-screen mode. In the illustrated example, the number of windows of apps running in the one-screen mode is three. Here, three windows W1, W2, and W3 are illustrated in the display area DA.

The window W1 is an active window arranged on the frontmost layer (the top layer). The window W2 is a window that was an active window before the window W1 has become the active window. The window W3 is a window that had been an active window before the window W2 became the active window. In other words, in the window priority order, the window W1 is the highest, and the window priority goes down in the order of the window W2 and the window W3.

When switching from the one-screen mode to the three-screen mode, the window W1 is maximized and displayed in the first display area DA1 as the active window according to the area priority and the window priority. In the second display area DA2, the window W2 is maximized and displayed as an inactive window. In the third display area DA3, the window W3 is maximized and displayed as another inactive window.

FIGS. 26A-26B are diagrams illustrating a third example of display control upon switching from the one-screen mode to the three-screen mode according to the present embodiment. FIG. 26A illustrates a display example of the one-screen mode, and FIG. 26B illustrates a display example after switching to the three-screen mode. In the illustrated example, the number of windows of apps running in the one-screen mode is four. Here, four windows W1, W2, W3, and W4 are illustrated in the display area DA.

The window W1 is an active window arranged on the frontmost layer (the top layer). In the window priority order, the window W1 is the highest, and the window priority goes down in the order of the window W2, the window W3, and window W4.

When switching from the one-screen mode to the three-screen mode, the window W1 is maximized and displayed in the first display area DA1 as the active window according to the area priority and the window priority. In the second display area DA2, a thumbnail window in which thumbnail images SW2, SW3, and SW4 of the windows W2, W3, and W4 are lined up is displayed. Note that the third display area DA3 is put into such a state that the desktop screen is displayed because of no window to be displayed. When the number of windows of apps running in the one-screen mode is five or more, the number of thumbnail images to be displayed in the second display area DA2 is four or more.

Here, when any one of the thumbnail images SW2, SW3, and SW4 being displayed in the second display area DA2 is selected, an inactive window corresponding to the selected thumbnail image is displayed in the second display area DA2 as an active window, and a thumbnail window in which the remaining thumbnail images are lined up is displayed in the third display area DA3.

Thus, in the case where switching from the one-screen mode to the three-screen mode is made, when the number of windows in the one-screen mode is more than three (more than the number of display areas in the three-screen mode), the information processing apparatus 10 displays, in the second display area DA2, a thumbnail window in which thumbnail images of windows except the active window among the windows in the one-screen mode are lined up is displayed. On the other hand, in the case where switching from the one-screen mode to the three-screen mode is made, when the number of windows in the one-screen mode is three or less (equal to or less than the number of display areas in the three-screen mode), the information processing apparatus 10 displays the inactive windows in the one-screen mode in the second display area DA2, the third display area DA3, and the like without displaying any thumbnail window.

In other words, when switching from the one-screen mode to the three-screen mode, the information processing apparatus 10 controls whether or not to display thumbnail images in the second display area DA2 based on the number of display areas in the three-screen mode and the number of windows in the one-screen mode.

Note that there is a case where a window of an app running in the one-screen mode is minimized. In such a case, the minimized window does not have to be included in the number of windows in the one-screen mode.

Note that the same applies to a case where switching from the one-screen mode to the four-screen mode is made. In the following, the description will be made by setting four display areas in the case of the four-screen mode as a first display area DA1, a second display area DA2, a third display area DA3, and a fourth display area DA4. For example, in the case where switching from the one-screen mode to the four-screen mode is made, when the number of windows in the one-screen mode is more than four (more than the number of display areas in the four-screen mode), the information processing apparatus 10 displays, in the second display area DA2, a thumbnail window in which thumbnail images of windows except the active window among windows in the one-screen mode are lined up. On the other hand, in the case where switching from the one-screen mode to the four-screen mode is made, when the number of windows in the one-screen mode is four or less (equal to or less than the number of display areas in the four-screen mode), the information processing apparatus 10 displays the inactive windows in the one-screen mode in the second display area DA2, the third display area DA3, the fourth display area DA4, and the like without displaying any thumbnail window.

In other words, when switching from the one-screen mode to the four-screen mode, the information processing apparatus 10 controls whether or not to display thumbnail images in the second display area DA2 based on the number of display areas in the four-screen mode and the number of windows in the one-screen mode.

Note that there is a case where a window of an app running in the one-screen mode is minimized. In such a case, the minimized window does not need to be included in the number of windows in the one-screen mode.

### (Operation of Thumbnail Window Display Control Processing)

Next, the operation of display control processing in which, when switching from the one-screen mode to a multi-screen mode, the control unit 18 controls whether or not to display a thumbnail window will be described. As the multi-screen mode, for example, the two-screen mode, the three-screen mode, the four-screen mode, and the like are included.

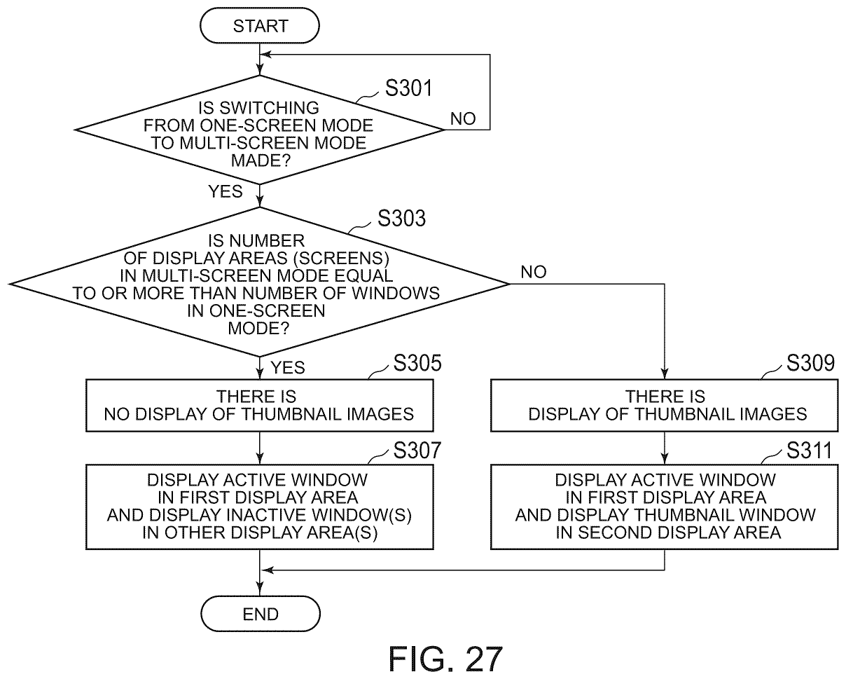

FIG. 27 is a flowchart illustrating an example of thumbnail window display control processing according to the present embodiment.

(Step S301) The control unit 18 determines whether or not to perform switching from the one-screen mode to the multi-screen mode. For example, the control unit 18 determines whether or not to switch from the one-screen mode to the multi-screen mode based on the detection of a change from the flat state (Flat form) to the bent state (Bent form) as described with reference to FIG. 4, a display mode switching operation described with reference to FIGS. 23A-23B, and the like. When determining that switching from the one-screen mode to the multi-screen mode is not made (NO), the control unit 18 continues the one-screen mode, and performs the process in step S301 again. On the other hand, when determining that switching from the one-screen mode to the multi-screen mode is made (YES), the control unit 18 switches to the multi-screen mode in which the display area DA is split into multiple display areas of a first display area DA1, a second display area DA2, a third display area DA3, a fourth display area DA4, and the like, and proceeds to a process in step S303.

(Step S303) The control unit 18 determines whether or not the number of display areas (screens) in the multi-screen mode after switching is equal to or more than the number of windows in the one-screen mode before switching to the multi-screen mode. When determining to be equal to or more than the number of windows in the one-screen mode (YES), the control unit 18 proceeds to a process in step S305. On the other hand, when determining to be less than the number of windows in the one-screen mode (NO), the control unit 18 proceeds to a process in step S309.

(Step S305) The control unit 18 sets that there is no display of a thumbnail window when switching to the multi-screen mode, and proceeds to a process in step S307.

(Step S307) The control unit 18 displays, in the first display area DA1, an active window in the one-screen mode, and displays an inactive window(s) in the one-screen mode in the other display area(s) (see FIGS. 8A-8B, FIGS. 24A-24B, and FIGS. 25A-25B). For example, the control unit 18 displays, in the display area(s) other than the first display area DA1, the inactive window(s) in the one-screen mode according to the area priority and the window priority. Note that, when the number of windows in the one-screen mode is less than the number of display areas (screens) in the multi-screen mode after switching, a display area with no window displayed therein is included in the display area(s) other than the first display area DA1.

(Step S309) The control unit 18 sets that there is the display of a thumbnail window when switching to the multi-screen mode, and proceeds to a process in step S311.

(Step S311) The control unit 18 displays, in the first display area DA1, the active window in the one-screen mode, and displays, in the second display area DA2, a thumbnail window in which thumbnail images of inactive windows in the one-screen mode are lined up (see FIGS. 7A-7B, FIGS. 10A-10B, and FIGS. 26A-26B).

Note that the example in which the thumbnail images (for example, the thumbnail window) are displayed in the second display area DA2 with the highest priority among the multiple second display areas except the first display area DA1 (that is, the area priority of which comes next to the first display area DA1) according to the preset area priority (see FIGS. 26A-26B) is described, but the area in which the thumbnail images (for example, the thumbnail window) are to be displayed is not limited to this example. For example, the control unit 18 may display the thumbnail images (for example, the thumbnail window) in an area with the last area priority among the multiple second display areas except the first display area DA1 in the display control processing. For example, the area with the last area priority among the multiple second display areas except the first display area DA1 is the third display area DA3 in the case of the three-screen mode, and the fourth display area DA4 in the case of the four-screen mode.

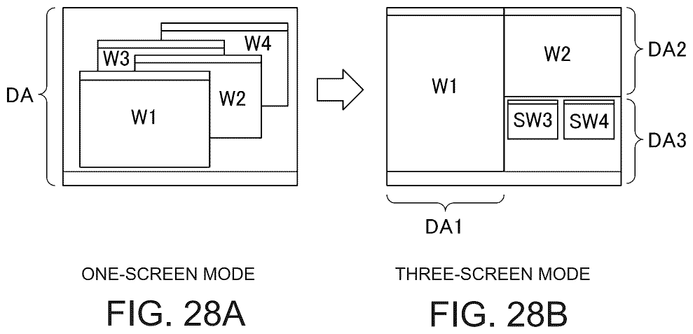

Here, an example in which thumbnail images (for example, a thumbnail window) are displayed in an area with the last area priority upon switching from the one-screen mode to the three-screen mode is illustrated in FIGS. 28A-28B.

FIGS. 28A-28B are diagrams illustrating a fourth example of display control upon switching from the one-screen mode to the three-screen mode according to the present embodiment, which is an example of displaying the thumbnail window in the third display area DA3 with the last area priority in the three-screen mode. FIG. 28A illustrates a display example of the one-screen mode, and FIG. 28B illustrates a display example after switching to the three-screen mode. In the illustrated example, the number of windows of apps running in the one-screen mode is four. Here, four windows W1, W2, W3, and W4 are illustrated in the display area DA.

The window W1 is an active window arranged on the frontmost layer (the top layer). In the window priority order, the window W1 is the highest, and the window priority goes down in the order of the window W2, the window W3, and the window W4.

When switching from the one-screen mode to the three-screen mode, the window W1 is maximized and displayed in the first display area DA1 as the active window according to the area priority and the window priority. In the second display area DA2, the window W2 is maximized and displayed as an inactive window. Further, in the third display area DA3 with the last area priority, a thumbnail window in which thumbnail images SW3 and SW4 of the windows W3 and W4 are lined up is displayed. Note that, when the number of windows of apps running in the one-screen mode is five or more, the number of thumbnail images to be displayed in the third display area DA3 is three or more.

Note that the same applies to a case where switching from the one-screen mode to the four-screen mode is made. For example, when switching from the one-screen mode to the four-screen mode, windows are maximized and displayed in the first display area DA1, the second display area DA2, and the third display area DA3, respectively, and a thumbnail window is displayed in the fourth display area DA4 with the last area priority.

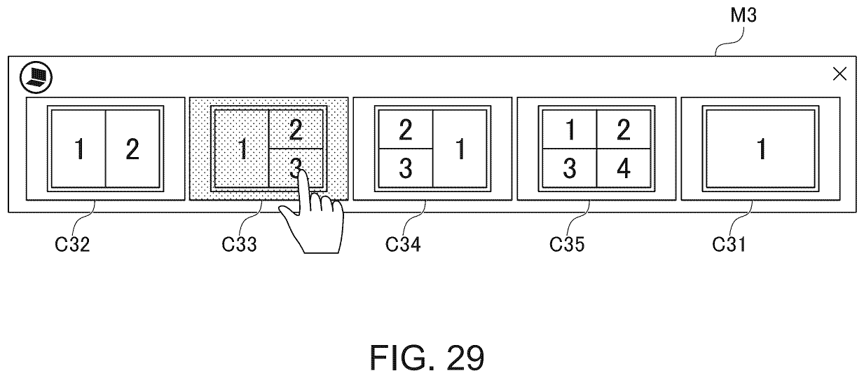

Referring next to FIG. 29 to FIG. 31B, an example of displaying a thumbnail window by a thumbnail display operation in the three-screen mode will be described.

FIG. 29 is a diagram illustrating an example of a thumbnail display operation according to the present embodiment. A switching menu M3 illustrated in FIG. 29 corresponds to the switching menu M3 illustrated in FIG. 23A. This switching menu M3 illustrated in FIG. 29 is displayed when the usage form is “Landscape” (the display mode (b), the display mode (d), the display mode (d′), or the like), which indicates that the current display mode is the three-screen mode corresponding to a display mode switching icon C33.

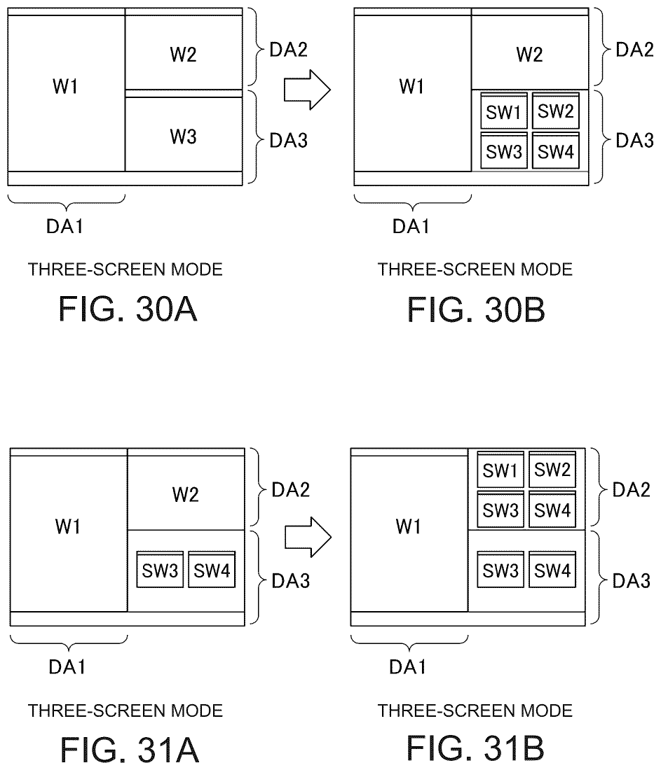

Since the display mode switching icon C33 is the current display mode, the display mode switching icon C33 is highlighted to distinguish from the other display mode switching icons C31, C32, C34, and C35. As described with reference to FIGS. 23A-23B, the display mode switching icons C31, C32, C34, and C35 function as operating elements for accepting user operations to switch among respective display modes. On the other hand, since the display mode switching icon C33 as the current display mode does not need to function as an operating element for switching the display mode, the display mode switching icon C33 functions as an operating element for displaying thumbnail images (a thumbnail window). Namely, the display mode switching icon C33 as the current display mode is displayed as an icon for accepting a thumbnail display operation. For example, an example of display control to display a thumbnail window in the third display area DA3 by the user performing an operation to select a display area indicated by “3” (the third display area DA3) on this display mode switching icon C33 is illustrated in FIGS. 30A-30B.

FIGS. 30A-30B are diagrams illustrating a first example of display control by a thumbnail display operation according to the present embodiment. FIG. 30A illustrates an example in which the window W1 is maximized and displayed in the first display area DA1, the window W2 is maximized and displayed in the second display area DA2, and the window W3 is maximized and displayed in the third display area DA3, respectively, in the three-screen mode. For example, when an operation to select the thumbnail image SW3 between the thumbnail images SW3 and SW4 being displayed in the third display area DA3 in FIG. 28B is performed, the display state is controlled to this display state illustrated in FIG. 30A. Note that the display state in FIG. 30A also corresponds to the display state illustrated in FIG. 25B.

In this display state illustrated in FIG. 30A, when the user performs the operation to select the display area indicated by “3” (the third display area DA3) on the display mode switching icon C33 as illustrated in FIG. 29, a thumbnail window is displayed in the third display area DA3 as illustrated in FIG. 30B. At this time, all thumbnail images of windows of running apps are displayed in the thumbnail window of the third display area DA3. For example, in the case where the number of windows of running apps is four (the windows W1, W2, W3, and W4) as illustrated in FIGS. 26A-26B or FIGS. 28A-28B, when the thumbnail display operation is performed, four thumbnail images (thumbnail images SW1, SW2, SW3, and SW4) are displayed in the third display area DA3 as illustrated in FIG. 30B.

The thumbnail display operation when the usage form is “Landscape” (the display mode (b), the display mode (d), the display mode (d′), or the like) is described with reference to FIG. 29 and FIGS. 30A-30B, but even when the usage form is “Clamshell” or “Portrait” (the display mode (c-1), the display mode (e), the display mode (e′), or the like), a thumbnail display operation can also be performed in the same way using the switching menu M4 illustrated in FIG. 23B.

The example of displaying the thumbnail window by specifying the third display area DA3 with the thumbnail display operation is described with reference to FIG. 29 and FIGS. 30A-30B. Next, an example of displaying a thumbnail window by specifying the second display area DA2 will be described with reference to FIGS. 31A-31B.

FIGS. 31A-31B are diagrams illustrating a second example of display control by a thumbnail display operation according to the present embodiment. FIG. 31A illustrates an example in which the window W1 is maximized and displayed in the first display area DA1, the window W2 is maximized and displayed in the second display area DA2, and a thumbnail window is displayed in the third display area DA3, respectively, in the three-screen mode. For example, this display state corresponds to the display state illustrated in FIG. 28B.

In this display state illustrated in FIG. 31A, when the user performs an operation to select the display area indicated by “2” (the second display area DA2) on the display mode switching icon C33 illustrated in FIG. 29, a thumbnail window is displayed in the second display area DA2 as illustrated in FIG. 31B. At this time, all thumbnail images of windows of running apps are displayed in the thumbnail window of the second display area DA2. For example, in the case where the number of windows of running apps is four (the windows W1, W2, W3, and W4) as illustrated in FIGS. 26A-26B or FIGS. 28A-28B, when a thumbnail display operation is performed, four thumbnail images (thumbnail images SW1, SW2, SW3, and SW4) are displayed in the second display area DA2 as illustrated in FIG. 31B.

Note that the same applies to a thumbnail display operation in the four-screen mode. For example, when a display mode corresponding to the display mode switching icon C35 illustrated in FIG. 29 is the current display mode, the display mode switching icon C35 functions as an operating element for displaying thumbnail images (a thumbnail window). When the user performs an operation to select any one of display areas respectively indicated by “1,” “2,” “3,” and “4” on the display mode switching icon C35, a thumbnail window is displayed in a display area selected from among the first display area DA1, the second display area DA2, the third display area DA3, and the fourth display area DA4.

As described above, in the information processing apparatus 10 according to the present embodiment, the control unit 18 performs display mode switching processing to control switching between the one-screen mode (the example of the first display mode) to control display using the entire screen area of the display 150 as one display area DA, and the multi-screen mode (another example of the second display mode) to control display by splitting the screen area of the display 150 into multiple (two, three, four, or the like) display areas. Further, the control unit 18 performs first display control processing in which, when switching from the one-screen mode to the multi-screen mode by the display mode switching processing, the control unit 18 displays, in the first display area DA1 among multiple display areas, an active window (the example of the one window) among windows of apps running in the one-screen mode, and displays, in a second display area (for example, the second display area DA2) except the first display area DA1 among the multiple display areas, thumbnail images corresponding to windows (for example, inactive windows) except the active window among the windows in the one-screen mode, and second display control processing to display the thumbnail images in a display area specified by a thumbnail display operation among the display areas inside the screen area of the display 150 due to the fact that the thumbnail display operation (the example of the predetermined operation) by the user is detected.

Thus, since the information processing apparatus 10 can display (redisplay) the thumbnail images of the windows of the running apps in any display area according to the user operation, operability when selecting windows to be displayed, respectively, in multiple display areas can be improved.

Further, when switching from the one-screen mode to the multi-screen mode by the display mode switching processing, the control unit 18 may also control whether or not to display, in the second display area DA2, a thumbnail window (thumbnail images) in the first display control processing based on the number of windows in the one-screen mode.

In such a case, when switching from the one-screen mode to the multi-screen mode, since the information processing apparatus 10 displays the active window in the one-screen mode before switching, and controls whether or not to display thumbnail images of inactive windows in a listable manner based on the number of windows in the one-screen mode, the display when switching from the one-screen mode to the multi-screen mode can be controlled properly.

Note that, according to the present embodiment, in the case where the number of windows in the one-screen mode is three, when switching from the one-screen mode to the two-screen mode, the control unit 18 displays thumbnail images (for example, a thumbnail window), while when switching to the three-screen mode, the control unit 18 does not display any thumbnail image (for example, any thumbnail window). Further, in the case where the number of windows in the one-screen mode is four, when switching from the one-screen mode to the two-screen mode or the three-screen mode, the control unit 18 displays thumbnail images (for example, a thumbnail window), while when switching to the four-screen mode, the control unit 18 does not display any thumbnail image (for example, any thumbnail window). In other words, it can also be said that the control unit 18 controls whether or not to display thumbnail images based on the number of display areas in the multi-screen mode when switching from the one-screen mode to the multi-screen mode.

Namely, when switching from the one-screen mode to the multi-screen mode by the display mode switching processing, the control unit 18 may also control whether or not to display thumbnail images (for example, a thumbnail window) in the second display area DA2 in the first display control processing based on the number of display areas in the multi-screen mode.

In such a case, when switching from the one-screen mode to the multi-screen mode, since the information processing apparatus 10 displays the active window in the one-screen mode before switching, and controls whether or not to display thumbnail images of inactive windows in a listable manner based on the number of display areas in the multi-screen mode after switching, the display when switching from the one-screen mode to the multi-screen mode can be controlled properly.

While the embodiments of this invention have been described in detail above with reference to the accompanying drawings, the specific configurations are not limited to those described above, and various design changes and the like can be made without departing from the scope of this invention. For example, the configurations described in the respective embodiments mentioned above may be combined arbitrarily.

Further, in the embodiments described above, three types of examples are described as examples of thumbnail display operations, that is, the first example in which a display mode switching icon corresponding to the current display mode among display mode switching icons (for example, the display mode switching icon C22 in FIG. 9 or FIG. 11, or the display mode switching icon C33 in FIG. 29) functions as an operating element for accepting a thumbnail display operation, a second example in which an operating element (for example, the thumbnail display icon C20A in FIG. 19) for displaying thumbnail images in all display areas (or in a preset display area(s)) is displayed separately from the display mode switching icons, and a third example in which an operating element (for example, the thumbnail display icon C20B in FIG. 21) capable of specifying (selecting) an area (split area) with thumbnail images to be displayed therein is displayed separately from the display mode switching icons. However, these three types of thumbnail display operations may also be made switchable in settings.

Note that each thumbnail display operation may be a specific pattern of touch operations on a display area in which the user wants to display thumbnail images. For example, a thumbnail window (thumbnail images) may be displayed using, as a trigger, a specific pattern of touch operations performed on a vacant area with no window displayed therein inside the screen area of the display 150, such as double taps, a multi-finger tap, or a multi-finger swipe. For example, when a specific pattern of touch operations is performed on a vacant area with no window displayed therein in any one of split display areas (for example, the first display area DA1, the second display area DA2, the third display area DA3, the fourth display area DA4, or the like) inside the screen area of the display 150, the information processing apparatus 10 may display a thumbnail window (thumbnail images) in the display area on which the touch operations are performed. Further, when a specific pattern of touch operations is performed on a vacant area with no window displayed therein inside a display area in which at least one window is already displayed (arranged) among the split display areas (for example, the first display area DA1, the second display area DA2, the third display area DA3, the fourth display area DA4, and the like) inside the screen area of the display 150, the information processing apparatus 10 may display a thumbnail window (thumbnail images) in the display area on which the touch operations are performed.

Further, in the embodiments described above, the example in which the foldable one display 150 is used in the one-screen mode and the two-screen mode is described, but two displays may also be used. In other words, the processing in the embodiments described above can also be applied to switching between a one-screen mode in which display is controlled by combining respective screen areas of the two displays into one display area, and a two-screen mode in which display is controlled using the respective screen areas of the two displays individually as display areas. Further, the processing in the embodiments described above can be applied to the three-screen mode or the four-screen mode in which display is controlled by splitting one or both of the respective screen areas of the two displays into two display areas.

Further, in the embodiments described above, the configuration of the information processing apparatus 10 having, as the multi-screen mode, the two-screen mode in which display is controlled by splitting the display area into two display areas, the three-screen mode in which display is controlled by splitting the display area into three display areas, and the four-screen mode in which display is controlled by splitting the display area into four display areas is described, but the information processing apparatus 10 may also be configured to have a screen mode in which display is controlled by splitting the display area into five or more display areas.

Further, in the embodiments described above, the example of touch operations on the multi-touch panel type display constructed by integrating the input unit (touch sensor) and the display unit together is described, but the operations are not limited to the touch operations, which may also be click operations with a mouse, operations with gestures, and the like.

Note that the control unit 18 described above has a computer system therein. Then, a program for implementing the function of each component included in the control unit 18 described above may be recorded on a computer-readable recording medium so that the program recorded on this recording medium is read into the computer system and executed to perform processing in each component included in the control unit 18 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the control unit 18, or delivery servers for delivering respective split pieces of the program may be different from one another. Further, it is assumed that the “computer-readable recording medium” includes a medium on which the program is held for a given length of time, such as a volatile memory (RAN) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions of the control unit 18 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

10 information processing apparatus
101 first chassis
102 second chassis
103 hinge mechanism
11 communication unit
12 RAM
13 storage unit
14 speaker
display unit
16 camera
150 display
155 touch sensor
161 first acceleration sensor
162 second acceleration sensor
17 Hall sensor
18 control unit
181 system processing unit
1811 running app information generating unit
182 detection processing unit
1821 open/close detection unit
1822 posture detection unit
1823 connection detection unit
1824 operation detection unit
183 display processing unit
1831 display mode determination unit
1832 display mode switching unit
1833 thumbnail generation unit
1834 display control unit

What is claimed is:

1. An information processing apparatus comprising:
a display;
a memory which stores a program of an application; and
a processor which executes the program of the application stored in the memory to perform control to display a window of the application on the display, wherein
the processor performs
display mode switching processing to control switching between a first display mode in which display is controlled using an entire screen area of the display as one display area, and a second display mode in which display is controlled by splitting the screen area of the display into multiple display areas,
first display control processing in which, when switching from the first display mode to the second display mode by the display mode switching processing, the processor displays, in a first display area among the multiple display areas, one window among windows of applications running in the first display mode, and displays, in a second display area except the first display area among the multiple display areas, thumbnail images corresponding to windows except the one window among the windows in the first display mode, and
second display control processing to display the thumbnail images in a display area specified with a predetermined operation by a user among the display areas inside the screen area due to a fact that the predetermined operation by the user is detected.

2. The information processing apparatus according to claim 1, wherein when displaying the thumbnail images in the second display control processing due to the fact that the predetermined operation is detected, the processor also displays a thumbnail image corresponding to the one window among the windows in the first display mode.

3. The information processing apparatus according to claim 1, wherein after performing control to hide the thumbnail images displayed in the second display area in the second display control processing, the processor displays the thumbnail images in a display area specified by the predetermined operation due to the fact that the predetermined operation is detected.

4. The information processing apparatus according to claim 1, wherein
the processor displays, in the screen area of the display, a first icon for accepting a user operation to switch from the first display mode to the second display mode, and
when a user operation on the first icon is detected in the first display mode, the processor switches from the first display mode to the second display mode, and
the processor accepts a user operation on the first icon as the predetermined operation in the second display mode, and when the operation on the first icon is detected, the processor determines that the predetermined operation is detected and displays the thumbnail images.

5. The information processing apparatus according to claim 1, wherein
the processor displays, in the screen area of the display, a first icon for accepting a user operation to switch from the first display mode to the second display mode, and a second icon for accepting the predetermined operation, and
when an operation on the second icon is detected, the processor determines that the predetermined operation is detected and displays the thumbnail images.

6. The information processing apparatus according to claim 5, wherein the second icon accepts an operation to specify a display area in which the thumbnail images are to be displayed from among the multiple display areas split in the second display mode.

7. The information processing apparatus according to claim 1, wherein the predetermined operation is a specific pattern of touch operations on a display area in which the user wants to display the thumbnail images.

8. The information processing apparatus according to claim 7, wherein
the predetermined operation is the specific pattern of touch operations on an area with no window displayed therein inside a display area in which at least one window is displayed among the multiple display areas in the second display mode, and
when the predetermined operation is detected, the processor displays the thumbnail images in a display area on which the predetermined operation is performed by the second display control processing.

9. The information processing apparatus according to claim 3, wherein when any one of the thumbnail images displayed in the second display area is selected with a user operation, the processor hides all the thumbnail images displayed in the second display area, and displays a window corresponding to the selected thumbnail image.

10. The information processing apparatus according to claim 3, wherein when a user operation for hiding the thumbnail images displayed in the second display area is performed, the processor hides all the thumbnail images displayed in the second display area.

11. The information processing apparatus according to claim 1, wherein when switching from the first display mode to the second display mode by the display mode switching processing, the processor controls whether or not to display the thumbnail images in the second display area in the first display control processing based on the number of windows in the first display mode.

12. The information processing apparatus according to claim 1, wherein when switching from the first display mode to the second display mode by the display mode switching processing, the processor controls whether or not to display the thumbnail images in the second display area in the first display control processing based on the number of display areas in the second display mode.

13. A control method for an information processing apparatus including: a display; a memory which stores a program of an application; and a processor which executes the program of the application stored in the memory to perform control to display a window of the application on the display, the control method comprising:
a display mode switching step of causing the processor to control switching between a first display mode in which display is controlled using an entire screen area of the display as one display area, and a second display mode in which display is controlled by splitting the screen area of the display into multiple display areas;
a first display control step in which, when switching from the first display mode to the second display mode by the display mode switching step, the processor displays, in a first display area among the multiple display areas, one window among windows of applications running in the first display mode, and displays, in a second display area except the first display area among the multiple display areas, thumbnail images corresponding to windows except the one window among the windows in the first display mode; and
a second display control step of causing the processor to display the thumbnail images in a display area specified with a predetermined operation by a user among the display areas inside the screen area due to a fact that the predetermined operation by the user is detected.
